(19) United States
(12) Patent Application Publication
(10) Pub. No.: US 2026/0147873 A1
(43) Pub. Date: May 28, 2026

(54) SKETCH MANAGEMENT SYSTEM, AND METHOD

(71) Applicant: NEC Corporation, Tokyo (JP)

(72) Inventors: Saki OTSUKI, Tokyo (JP); Hiroto TAMIYA, Tokyo (JP); Toshiyuki ISSHIKI, Tokyo (JP)

(73) Assignee: NEC Corporation, Tokyo (JP)

(21) Appl. No.: 19/394,456

(22) Filed: Nov. 19, 2025

(30) Foreign Application Priority Data
Nov. 22, 2024 (JP) 2024-203850

(51) Int. Cl. G06F 21/45

(52) U.S. Cl. CPC G06F 21/45

(57) ABSTRACT

Provided a first apparatus configured to, regarding a first sketch generated using first data and first biometric information and registered in advance, acquire anew first biometric information, generate second data, generate a third sketch using second data and the first biometric information acquired anew, acquire second biometric information, and generate a fourth sketch using the second data and second biometric information, and a second apparatus configured to restore difference data based on the first sketch and the third sketch generated by the first apparatus and generate a second sketch using the fourth sketch generated by the first apparatus and the difference data.

### CROSS REFERENCE TO RELATED APPLICATIONS

This application is based upon and claims the benefit of the priority of Japanese patent application No. 2024-203850, filed on Nov. 22, 2024, the disclosure of which is incorporated herein in its entirety by reference thereto.

### FIELD

The present disclosure relates to a sketch management system, method.

### BACKGROUND

Sketches generated using biometric information, etc., are employed in such applications as biometric authentication, biometric cryptography, and biometric signature. Non-Patent Literature (NPL) 1 discloses generating a sketch using biometric information and an error-correcting code.

### CITATION LIST

NPL 1: Yevgeniy Dodis, Rafail Ostrovsky, Leonid Reyzin, and Adam Smith, “Fuzzy Extractors: How to Generate Strong Keys from Biometrics and Other Noisy Data”, SIAM Journal on Computing, 38(1):97-139, 2008

### SUMMARY

It is desirably proposed that regarding a sketch that has been registered as a biometric template or the like, a sketch corresponding to new biometric information of a user is enabled to be registered as a new biometric template or the like to accommodate update or change of the biometric information of the user.

The present disclosure provides a system, method, apparatus, program, and non-transitory recording medium, each enabling generation of a new sketch for a sketch registered in advance while ensuring security.

According to one aspect of the present disclosure, a sketch management system includes a first apparatus configured to perform:
regarding a first sketch generated using first data and first biometric information and registered in advance, acquiring anew first biometric information;
generating second data;
generating a third sketch using the second data and the first biometric information acquired anew;
acquiring second biometric information; and
generating a fourth sketch using the second data and the second biometric information, and
a second apparatus configured to perform:
obtaining the third sketch generated by the first apparatus;
restoring difference data based on the first sketch and the third sketch, wherein the difference data corresponds to difference between the first data and the second data when difference between the first biometric information acquired anew and the first biometric information used to generate the first sketch is within a predetermined range;
obtaining the fourth sketch generated by the first apparatus; and generating a second sketch using the fourth sketch and the difference data.

According to another aspect of the present disclosure, a sketch management system includes:
a first apparatus configured to perform, with respect to a first sketch generated using first data and first biometric information and registered in advance, acquiring the first biometric information anew;
generating second data; and
generating a third sketch using the second data and the first biometric information acquired anew; and
a second apparatus configured to perform:
obtaining the third sketch generated by the first apparatus;
restoring difference data based on the first sketch and the third sketch, wherein the difference data corresponds to difference between the first data and the second data when difference between the first biometric information acquired anew and the first biometric information used to generate the first sketch is within a predetermined range; and
generating a second sketch using the difference data and the third sketch.

According to a further aspect of the present disclosure, a sketch management system includes:
a first apparatus configured to perform:
regarding a first sketch generated using first data and first biometric information and registered in advance, acquiring the first biometric information anew; and
generating a third sketch using second data and the first biometric information acquired anew;
a third apparatus configured to perform:
acquiring second biometric information; and
generating a fourth sketch using the second data and the acquired second biometric information, the first apparatus and the third apparatus sharing the second data using a key sharing protocol; and
a second apparatus configured to perform:
obtaining the third sketch generated by the first apparatus;
restoring difference data based on the first sketch and the third sketch, wherein the difference data corresponds to difference between the first data and the second data when difference between the first biometric information acquired anew and the first biometric information used to generate the first sketch is within a predetermined range;
obtaining the fourth sketch generated by the third apparatus; and generating a second sketch using the fourth sketch and the difference data.

According to one aspect of the present disclosure, a method includes:
by first apparatus:
with respect to a first sketch generated using the first data and the first biometric information and registered in advance, acquiring the first biometric information anew;
generating the second data;
generating a third sketch using the second data and the first biometric information acquired anew;
acquires second biometric information; and
generating a fourth sketch using the second data and the second biometric information, the method includes:
by a second apparatus:
obtaining the third sketch generated by the first apparatus;
restoring difference data based on the first sketch and the third sketch, wherein the difference data corresponds to difference between the first data and the second data when the difference between the first biometric information acquired anew and the first biometric information used to generate the first sketch is within a predetermined range;
obtaining the fourth sketch generated by the first apparatus, and generate a second sketch using the fourth sketch and the difference data.

According to another aspects of the present disclosure, methods corresponding to another and further aspects of the sketch management system are disclosed.

According to the present disclosure, a non-transitory recording medium corresponding to the above-described one aspect of the sketch management system, stores a program causing a first processing apparatus to execute:
with respect to a first sketch generated using the first data and the first biometric information and registered in advance, acquiring the first biometric information anew;
generating second data;
generating a third sketch using the second data and the first biometric information acquired anew;
acquiring second biometric information;
generating a fourth sketch using the second data and the second biometric information, the non-transitory recording medium storing a program causing a second processing apparatus to execute:
obtaining the third sketch generated by the first processing apparatus;
restoring difference data based on the first sketch and the third sketch, wherein the difference data corresponds to difference between the first data and the second data when the difference between the first biometric information acquired a new and used to generate the third sketch and the first biometric information used to generate the first sketch is within a predetermined range;
obtaining the fourth sketch generated by the first processing apparatus; and
generating a second sketch using the fourth sketch and the difference data.

According to the present disclosure, a sketch management apparatus includes a processor and communication interface. The processor is configured to:
regarding a first sketch generated using first data and first biometric information and registered in advance,
receive a third sketch generated using the first biometric information acquired anew and second data;
restore difference data based on the first sketch and the third sketch, wherein the difference data corresponds to difference between the first data and the second data when difference between the first biometric information acquired anew and used to generate the third sketch and the first biometric information used to generate the first sketch is within a predetermined range;
as a process for generating a second sketch from the first sketch,
in case where the second sketch is a sketch generated using the first data and the second biometric information,
receive a fourth sketch generated using the second data and the second biometric information, and
generate the second sketch using the fourth sketch and the difference data;
in case where the second sketch is a sketch generated using the first data and the first biometric information acquired anew,
generate the second sketch using the third sketch and the difference data.

According to the present disclosure, a non-transitory recording medium stores a program causing a processor to execute processing including:
regarding a first sketch generated using first data and first biometric information and registered in advance,
receiving a third sketch generated using the first biometric information acquired anew and second data;
restoring difference data based on the first sketch and the third sketch, wherein the difference data corresponds to difference between the first data and the second data when difference between the first biometric information acquired anew and used to generate the third sketch and the first biometric information used to generate the first sketch is within a predetermined range;
as a process for generating a second sketch from the first sketch,
in case where the second sketch is a sketch generated using the first data and the second biometric information,
receiving a fourth sketch generated using the second data and the second biometric information, and
generating the second sketch using the fourth sketch and the difference data;
in case where the second sketch is a sketch generated using the first data and the first biometric information acquired anew,
generating the second sketch using the third sketch and the difference data.

According to the present disclosure, it is possible to generate a new sketch for a sketch registered in advance while ensuring security.

### BRIEF DESCRIPTION OF THE DRAWINGS

FIG. 1 is a diagram illustrating a comparative example.

FIG. 2 is a diagram illustrating an example of several embodiments.

FIG. 3 is a diagram illustrating an example of several embodiments.

FIG. 4 is a diagram illustrating an example of several embodiments.

FIG. 5 is a diagram illustrating an example of several embodiments.

FIG. 6 is a diagram illustrating an example of several embodiments.

FIG. 7 is a diagram illustrating an example of several embodiments.

FIG. 8 is a diagram illustrating an example of several embodiments.

FIG. 9 is a diagram illustrating an example of several embodiments.

FIG. 10A and FIG. 10B are diagrams illustrating examples of several embodiments.

FIG. 11 is a diagram illustrating an example of a sketch management apparatus for several embodiments.

### EXAMPLE EMBODIMENTS

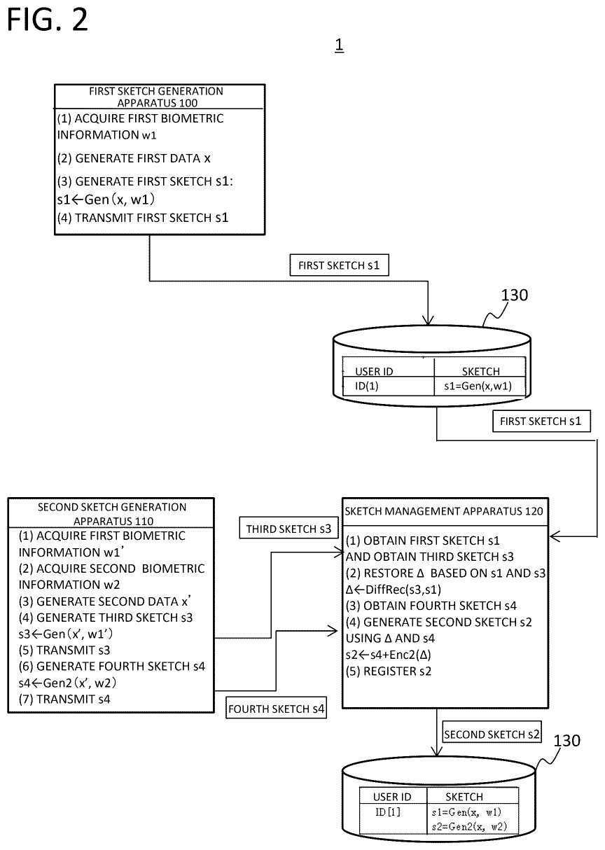

The following describes embodiments of the present disclosure. According to one of example embodiments of the present disclosure, a sketch management system (designated by e.g., reference numeral 1 in FIG. 2) includes a first apparatus (first processing apparatus) (designated by e.g., reference numeral 100 in FIG. 2) and a second apparatus (second processing apparatus) (designated by e.g., reference numeral 110 in FIG. 2). The first apparatus is configured to:
with respect to a first sketch (s1) that was generated using first data (x) and first biometric information (w1) and registered in advance,
acquire anew first biometric information (w1′),
generate second data (x′),
generate a third sketch (s3) using the second data (x′) and the first biometric information acquired anew (w1′),
acquire a second biometric information (w2), and
generate a fourth sketch (s4) using the second data (x′) and the second biometric information (w2).

The second apparatus is configured to:
obtain the third sketch (s3) generated by the first apparatus (110),
restore difference data (A) based on the first sketch (s1) registered in advance and the third sketch (s3),
obtain the fourth sketch (s4) generated by the first apparatus (110), and
generate a second sketch (s2) using the fourth sketch (s4) and the difference data (Δ).

The difference data (Δ) restored based on the first sketch (s1) and the third sketch (s3) is equal to difference (x-x′) between the first data x and the second data x′, when difference between the first biometric information (w1′) acquired anew and used to generate the third sketch (s3) and the first biometric information (w1) used to generate the first sketch (s1) registered in advance is within a predetermined range.

The first biometric information (w1′) acquired anew is first biometric information acquired again (newly) after acquiring the first biometric information (w1) used to generate the first sketch (s1) for registration. The first biometric information (w1′) acquired anew has a modality identical to that of the first biometric information (w1). The first biometric information acquired anew may be simply referred to as the new first biometric information. A modality of biometric information may refer to a type of biometric information.

The following outlines a sketch generated by using an error-correcting code and biometric information.

In a sketch generation procedure, a sketch s may be generated by using, for example, a codeword c obtained by encoding data x (e.g., random data) using an error-correcting coding (ECC) and biometric information w of a user (reference may be made to a linear sketch disclosed in Reference Literature 1, etc.). A generation function Gen to generate a sketch sis given, for example, by:

$$s ← Gen ( x , w ) = E n c ( x ) + w ( = c + w ) \qquad ( 1 )$$

In Equation (1), Enc is an error-correcting encoding function. It is noted that in Equation (1), the operation is not limited to addition. It may be subtraction. The operation symbol “+” does not need be an arithmetic operation. It may be a logical operation such as bitwise exclusive OR. For example, using a codeword c and biometric information w, a sketch s may be constructed by the following Equation (2) (Juels-Watenberg Fuzzy commitment).

$$s = c ⊕ w \qquad ( 2 )$$

where ⊕ is a bitwise exclusive OR.

Regarding the sketch s generated using Equation (1), a recovery procedure may, for example, use the sketch s and user's biometric information w′ (assumed to be close to w used to generate the sketch s)

$${x}^{′} ← Rec ( {w}^{′} , s ) = x , if d ( w , {w}^{′} ) ≦ t \qquad ( 3 )$$

That is, if a distance d(w, w′) which corresponds to difference between the two biometric data w and w′ is close (d(w, w′)≤t, where tis a correction capability of an error-correction code), an output x′ of the recovery function Rec(w′, s) is equal to x (x′=x).

Using an error-correcting decoding function Dec corresponding to the error-correction encoding function Enc in Equation (1), the recovery function Rec(w′, s) in Equation (3) may be defined, for example, as follows.

$$Rec ( {w}^{′} , s ) = D e c ( s - {w}^{′} ) = D e c ( c + ( w - {w}^{′} ) ) \qquad ( 4 )$$

If d(w, w′)≤t, a decoding result of c+(w−w′) in Equation (4) becomes the data x. It is noted that a notation for input arguments in the recovery function Rec(w′, s) is identical to that in Non-Patent Literature 1, but such a notation as Rec(s, w′) may be also used.

Similarly, when the sketch s is generated using Equation (2), Equation (4) becomes as follows.

$$Dec ( {c}^{′} ) = Dec ( s ⊕ {w}^{′} ) = Dec ( c ⊕ ( w ⊕ {w}^{′} ) ) \qquad ( 5 )$$

If a distance (Hamming distance) between w and w′ is small (i.e., d(w, w′)≤t), x can be recovered from Equation (5).

NPL 1 discloses a n example (Code-Offset Construction) wherein correction of an error(s) in biometric information w using an error-correcting code involves shifting a uniformly random codeword c to match up with the biometric information w and storing a shift as a sketch.

$$s ← S S ( w ) = w - c \qquad ( 6 )$$

SS(w) in Equation (6) is a function that generates a sketch s from the biometric information w. A decoding function decode may be configured to find a codeword c for a given w with a distance (Hamming distance) d(w, c) being less than or equal to t (decode is not an inverse function of the error-correcting encoding function Enc). A recovery function Rec (w′,s) may be computed by subtracting the shift s from w′ to get c′=w′−s and then decoding c′ to get c.

$$Rec ( {w}^{′} , s ) = s + decode ( {w}^{′} - s ) = s + c = w , if d ( w , {w}^{′} ) \leq t \qquad ( 7 )$$

Equation (7) corresponds to the following recovery function Rec in Equation (8) for a secure sketch, which is guaranteed by the correctness property of a secure sketch.

$$R e c ( {w}^{′} , s ) = w , if d ( w , {w}^{′} ) \leq t \qquad ( 8 )$$

When the sketch s (=w−c) in Equation (6) is made to correspond to one with a sign inverted by replacing the operation “+” in Equation (1) with “−”, and the error-correcting decoding function Dec in Equation (4) is used instead of the decode in Equation (7), we have:

$$Dec ( {w}^{′} - s ) = D e c ( {w}^{′} - ( w - c ) ) = D e c ( c + ( {w}^{′} - w ) ) = x , if d ( w , {w}^{′} ) \leq t \qquad ( 9 )$$

By adding the sketch s in Equation (6) to the encoded codeword c (=Enc(x)) obtained by encoding an error-corrected decoding result x of Equation (9), we have, for the sketch s generated by Equation (1), the following:

$$R e c ( {w}^{′} , s ) = s + c = w \qquad ( 10 )$$

The above may define a function to recover w based on w′ and the sketch s. The present disclosure may include as a sketch, a linear sketch, a secure sketch, a fuzzy commitment (Reference Literature 2) and so forth.

### Hypothetical Comparative Example

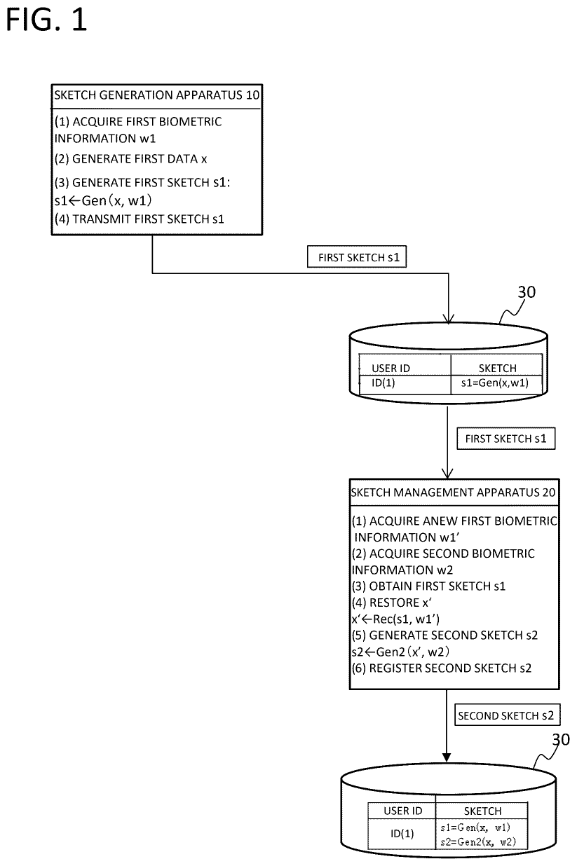

FIG. 1 illustrates a system example (hypothetical comparative example) that performs generation and registration of a sketch corresponding to a new biometric information of a user based on a sketch of the user registered in advance in a storage apparatus. In FIG. 1, numbers in parentheses in each apparatus list an example of a processing step number executed by each apparatus. It is noted that the processing in a relevant apparatus is not necessarily executed in an order of the step number.

In a registration phase for registering a sketch as a template in a storage apparatus 30, a sketch generation apparatus 10 acquires first biometric information w1 of a user (Step 1), acquires first data x (Step 2). Step 1 and Step 2 may be interchanged in order. The sketch generation apparatus 10 generates a first sketch s1 using the first biometric information w1 and the first data x (Step 3).

$$s 1 ← Gen ( x , w 1 ) \qquad ( 11 )$$

where Gen is a sketch generation function. For example, Gen outputs a value by combining a codeword c=Enc1(x) and the first biometric information w1, where c is an encoded value of the first data x using an error-correcting encoding function Enc1.

$$Gen ( x , w 1 ) = Enc 1 ( x ) + w 1 = c + w 1 \qquad ( 12 )$$

In Equation (12), as described above, an operator “+” may be subtraction or bitwise exclusive OR.

The first data x may be secret information, such as a secret key (signing key) of a user.

The sketch generation apparatus 10 transmits the first sketch s1 (=c+w) for registration (enrollment) in the storage apparatus 30. The storage apparatus 30 may be configured, for example, as a server. The storage apparatus 30 may store the first sketch s1 in association with, for example, a user ID (identifier). Although not particularly limited thereto, the user ID may be transmitted along with the first sketch s1 when the sketch generation apparatus 10 requests registration of the first sketch s1 to the storage apparatus 30. A terminal ID or address of the sketch generation apparatus 10 may be assigned as the user ID. Alternatively, depending on the implementation, a user account used when logging into an application that registers the first sketch s1 generated by the sketch generation apparatus 10 to the storage apparatus 30 (e.g., a server) may be used as the user ID.

The following studies a case where second biometric information w2, different from the first biometric information w1, is acquired and a second sketch s2 generated based on the second biometric information w2 and the first data x that was used to generate the first sketch s1 and registered in advance in the storage apparatus 30 is newly registered as a new first sketch.

This corresponds to a case of registering a second sketch s2 corresponding to the second biometric information w2 of the same user as the first biometric information w1 but of a different modality to cope with a case where the biometric information w1 registered as the first sketch s1 cannot be used (e.g., the first biometric information w1 is facial information of the user but cannot be used in low light, or the first biometric information w1 is finger vein information but the user who registered the first biometric information w1 has injured his/her finger, rendering the first biometric information w1 unusable). It is noted that the second biometric information w2 may be biometric information, a modality and user of which are the same as those of the first biometric information w1, while a body part of which is different from that of the first biometric information w1. As described above, a modality of biometric information indicates a type of biometric information. For example, if the first biometric information w1 is facial information and the second biometric information w2 is finger vein information, their modalities are different. Furthermore, if the first biometric information w1 and the second biometric information w2 are finger vein information acquired from an index finger and a middle finger, respectively, their modalities are the same, but body parts (biometric locations) are different.

In FIG. 1, the sketch generation apparatus 10 may be configured as a smartphone or the like. Alternatively, the sketch generation apparatus 10 may be a terminal or similar apparatus installed at, for example, a store, facility, or other location where the user receives a service. The sketch generation apparatus 10 may be equipped with a sensor(s) not shown for acquiring biometric information, or it may be configured to communicate with a sensor(s) via short-range communication such as Bluetooth® or via USB (Universal Serial Bus) or similar means.

It is possible for the sketch generation apparatus 10 to retain the first data x, which is secret information (such as a secret key), acquire the second biometric information w2, generate the second sketch s2, and register the second sketch s2 in the storage apparatus 30. However, this never involve using the first sketch s1 registered in advance to generate a second sketch s2 (the first sketch s1 is not involved in generating the second sketch s2) and thus falls outside the subject matter of the present disclosure. In a case where the sketch generation apparatus 10 is to generate the second sketch s2 using newly generated first data x1 (e.g., random data) and the second biometric information w2, the newly generated first data x1 (e.g., random data) may have a different value from the first data x involved in generating the first sketch s1 registered in advance. As a result, a value y1=f(x1) (e.g., y1 being a public key or the like, and f being a generating function thereof) generated corresponding to the newly generated first data x1 would be a different value from the value y=f(x) (where y is, for example, a public key, etc.) generated corresponding to the first data x. Therefore, in this respect as well, this case does not correspond to generating the second sketch s2 using the first sketch s1 registered in advance.

The subject matter of the present disclosure involves generating securely a second sketch s2 from a first sketch s1 registered in advance. It is noted that In FIG. 1, the sketch generation apparatus 10 is shown for description of an example of generation and registration of the first sketch s1.

The sketch management apparatus 20 acquires anew first biometric information w1′ of a user (Step 1). The first biometric information w1′ acquired anew by the sketch management apparatus 20 may be referred to as “the new first biometric information w1′. The new first biometric information w1′ is assumed to be identical to the first biometric information w1 used to generate the first sketch s1, with respect to a user, modality, and body part. If the new first biometric information w1′ differs from the first biometric information w1 in at least one of a user, modality, or body part, the generation of the second sketch s2 will not be performed correctly.

The sketch management apparatus 20 acquires second biometric information w2 of the user (Step 2). The second biometric information w2 may be, for example, biometric information of the same user as the first biometric information w1 used to generate the first sketch s1, but with a different modality; or it may be biometric information of the same user as the first biometric information w1, with the same modality but a different body part. The new first biometric information w1′ and second biometric information w2 may be acquired by the sketch generation apparatus 10 and transmitted to the sketch management apparatus 20. Alternatively, the first biometric information w1′ may be acquired by the sketch generation apparatus 10, and the second biometric information w2 may be acquired by a separate apparatus (terminal) not shown, with each transmitting the first biometric information w1′ and the second biometric information w2 to the sketch management apparatus 20. The sketch management apparatus 20 may obtain an user ID corresponding to the new first biometric information w1.

The sketch management apparatus 20 obtains the first sketch s1 registered in the storage apparatus 30 (Step 3). The sketch management apparatus 20 may read out the first sketch s1 corresponding to the user ID from the storage apparatus 30. The sketch management apparatus 20 uses a recovery function Rec which takes the first sketch s1 and the first biometric information w1′ acquired anew as input to restore data x′ (Step 4). When the recovery function Rec (w1′, s1) is defined, for example, as an error-correcting decoding function Dec1 which takes s1−w1′ as input, the data x′ may be restored as follows:

$${x}^{′} ← Rec ( w {1}^{′} , s 1 ) = Dec 1 ( s 1 - w {1}^{′} ) = Dec 1 ( Enc 1 ( x ) + w 1 - w {1}^{′} ) = Dec 1 ( c + ( w 1 - w {1}^{′} ) ) \qquad ( 13 )$$

From Equation (13), if a distance d(w1, w1′) between the first biometric information w1 and the new first biometric information w1′ is less than or equal to t (where t is an error-correction capability of an error-correcting code), then, the result x′ of decoding (s1−w1′) by the decoding function Dec1 is equal to the first data x.

$${x}^{′} ← Rec ( w {1}^{′} , s 1 ) = x \qquad ( 14 )$$

The sketch management apparatus 20 generates a second sketch s2 using the restored data x′ and the second biometric information w2 (Step 5) and registers the second sketch s2 in the storage apparatus 30 (Step 6).

$$s 2 ← Gen 2 ( {x}^{′} , w 2 ) = Enc 2 ( {x}^{′} ) + w 2 \qquad ( 15 )$$

It is noted that the encoding function Enc1 used to generate the first sketch s1 and the encoding function Enc2 used to generate the second sketch s2 may differ in at least one of parameters of a [n, k, 2t+1] linear code, such as a code length n, the number of information bits k, or an error-correction capability t (e.g., a number of blocks contained in a codeword or a length of one block (bit length)). Furthermore, when the first biometric information w1 is, for example, a feature vector of a facial image, and the second biometric information w2 is, for example, a binary vector of finger vein patterns, Enc1 and Enc2 are encoding functions different in processing. When the first biometric information w1 is a binary vector of finger vein patterns (e.g., index finger) and the second biometric information w2 is a binary vector of finger vein patterns (e.g., middle finger), Enc1 and Enc2 may be the same encoding function. It is noted that in Equation (15), the function name of the generation function Gen2 indicates that Enc2 is used as the encoding function.

In FIG. 1, the storage apparatus 30 may be configured as being built into the sketch management apparatus 20, or it may be a database (e.g., a database (DB) server) connected to the sketch management apparatus 20 via communication. In the sketch management apparatus 20, a register(s) or a memory configured to temporarily hold the first biometric information w1′ acquired anew and the second biometric information w2, may be reset, by zero-clearing or the like, after the completion of Steps 4 and 5 in the sketch management apparatus 20, to prevent leakage or compromise.

As described above, in the hypothetical comparative example of FIG. 1, if the distance d(w1, w1′) between the first biometric information w1 and the new first biometric information w1′ is less than or equal to the correction capability t of the error-correcting code, then x′=x (Equation (14)). That is, the first data x that is secret information is revealed in the sketch management apparatus 20 other than the sketch generation apparatus 10 that has generated the first data x, which may potentially lead to leakage. On the other hand, if d(w1, w1′)>t, then from Equation (13), x′=x does not hold. In this case, since the second sketch s2 is not generated using the first data x (Equation (15)), the second sketch s2 cannot be used as a registration template (e.g., a public key corresponding to the first data x (secret key) cannot be used).

The above is an issue(s) identified by analysis of the hypothetical comparative example. The following embodiments address at least the above issue(s).

According to the present disclosure, for example, second data x′ which is temporary data is generated. Using the second data x′ and first biometric information w1′ acquired anew (or, the first biometric information w1′ acquired anew and second biometric information w2), a third sketch s3 (or, third and fourth sketches s3 and s4) is/are generated. By performing processing using linearity of sketches on the first sketch s1 and the third sketch s3, difference data Δ between the first data x and the second data x′ is restored (recovered). A second sketch s2 is then generated using the third sketch s3 (or fourth sketch s4) and the difference data Δ. This enables generation of a desired second sketch s2 while the first data x involved in generating the first sketch s1 registered in advance is kept concealed and the first biometric information w1 is also kept concealed.

FIG. 2 illustrates an example system according to a n embodiment. FIG. 2 illustrates an example of generating a second sketch s2 using the first data x and second biometric information w2, without revealing the first data x, based on the first sketch s1 that was generated using the first biometric information w1 and the first data x and has been stored in the storage apparatus 130. It is noted that the sketch numbers (s1 to s4, etc.) are assigned based on the premise of generating the second sketch s2 from the first sketch s1 in order to correspond with FIG. 1. However, the numbering of sketches is arbitrary. In FIG. 2, the numbers within parentheses in the apparatus represent examples of processing step numbers (the processing order may not necessarily follow a sequence of the processing step numbers).

In FIG. 2, the first sketch generation apparatus 100 corresponds to the sketch generation apparatus 10 in FIG. 1. More specifically, the first sketch generation apparatus 100 acquires first biometric information w1 of a user (Step 1), generates first data x (Step 2), and generates a first sketch s1 using the first biometric information w1 and the first data x (Step 3). For example, the first sketch s1 is obtained by combining a codeword c (=Enc1(x)) of the first data x encoded by the error correcting encoding function Enc1 and the first biometric information w1.

$$s 1 ← G e n ( x , w 1 ) = c + w 1 = Enc 1 ( x ) + w 1 \qquad ( 16 )$$

As the encoding function Enc1, a linear code, specifically an Error-Correcting Linear Code (ECLC), may be used. In this case, the following linearity holds for data x1 and x2:

$$Enc 1 ( x 1 ) + Enc 1 ( x 2 ) = Enc 1 ( x 1 + x 2 ) \qquad ( 17 )$$

For encoding, an error-correcting code (e.g., Hamming code, BCH (Bose-Chaudhuri-Hocquenghem) code, RS (Reed-Solomon) code, LDPC (low-density parity-check) code, etc.) may be used. Alternatively, lattice coding may be used. More specifically, lattice coding using an integer lattice or a triangular lattice, as well as more complex lattice, may be used (see Reference 2, etc.).

It is noted that in the sketch generation apparatus 10 of FIG. 1, it is not necessarily required to use a linear code in the encoding function Enc1.

The first sketch generation apparatus 100 transmits the first sketch s1 to the storage apparatus 130 for registration therein. The storage apparatus 130 may manage and store the first sketch s1, for example, corresponding to a user ID, similar to the storage apparatus 30 in FIG. 1. It is noted that in FIG. 2, only one record is shown in the storage apparatus 130 only for the sake of simplicity in the drawing. Furthermore, while the record is shown as having fields for the user ID and the first sketch s1, the configuration is not limited thereto.

When generating a second sketch s2 using second biometric information w2 from the first sketch s1 registered in storage apparatus 130, the second sketch generation apparatus 110 acquires anew first biometric information w1′ from the same user as the first biometric information w1 used to generate the first sketch s1 (Step 1). The first biometric information w1′ acquired anew by the second sketch generation apparatus 110 may be referred to as the new first biometric information. The new first biometric information w1′ is considered identical to the first biometric information w1 in terms of a modality, body part, and user. The first sketch generation apparatus 100 and the second sketch generation apparatus 110 may be located at different sites. Alternatively, the second sketch generation apparatus 110 may be the same apparatus (terminal) as the first sketch generation apparatus 100 that generated the first sketch s1. In this case, when the first biometric information w1 is, for example, facial information (finger vein information), the user will again hold his/her face (same finger) in front of a camera (sensor) of the first sketch generation apparatus 100. The first sketch generation apparatus 100 and the second sketch generation apparatus 110 may also be implemented as a single integrated apparatus.

The second sketch generation apparatus 110 acquires second biometric information w2 of the user (e.g., having a different modality from the first biometric information w1) (Step 2).

The second sketch generation apparatus 110 generates second data x′ (Step 3). The second data x′ may be referred to as temporary secret information and May for example, be an integer value chosen uniformly at random.

The second sketch generation apparatus 110 generates a third sketch s3 using the second data x′ and the new first biometric information w1′ (Step 4). The second sketch generation apparatus 110 may generate the third sketch s3 by combining a codeword c′ (=Enc1(x′)) of the second data x′ encoded using the encoding function Enc1 and the new first biometric information w1′, as below.

$$s 3 ← Gen ( {x}^{′} , w {1}^{′} ) = {c}^{′} + w {1}^{′} = Enc 1 ( {x}^{′} ) + w {1}^{′} \qquad ( 18 )$$

The second sketch generation apparatus 110 transmits the third sketch s3 to the sketch management apparatus 120 (Step 5). The second sketch generation apparatus 110 may transmit the third sketch s3 along with a user ID.

The second sketch generation apparatus 110 generates a fourth sketch s4 using the second data x′ and the second biometric information w2 (Step 6). The second sketch generation apparatus 110 may generate the fourth sketch s4 by combining a codeword c′ (=Enc2(x′)) of the second data x′ encoded using the encoding function Enc2 and the second biometric information w2, as below.

$$s 4 ← G e n ( {x}^{′} , w 2 ) = {c}^{′} + w 2 = Enc 2 ( {x}^{′} ) + w 2 \qquad ( 19 )$$

The encoding function Enc2 may employ an error-correcting linear code.

The second sketch generation apparatus 110 transmits the fourth sketch s4 to a sketch management apparatus 120 (Step 7). The second sketch generation apparatus 110 may transmit the fourth sketch s4 along with the user ID.

The sketch management apparatus 120 obtains the first sketch s1 that was generated by the first sketch generation apparatus 100 and has been stored in the storage apparatus 130. The sketch management apparatus 120 obtains (receives) the third sketch s3 generated and transmitted by the second sketch generation apparatus 110 (Step 1). In this case, the sketch management apparatus 120 may search the storage apparatus 130 using the user ID transmitted from the second sketch generation apparatus 110 along with the third sketch s3 and read out from the storage apparatus 130 the first sketch s1 stored corresponding to the user ID.

The sketch management apparatus 120 reconstructs difference data Δ between the first data x and the second data x′ based on the first sketch s1 and the third sketch s3 (Step 2). The sketch management apparatus 120 may use a reconstruction function DiffRec (difference recovery function) to which the first sketch s1 and the third sketch s3 is inputted to reconstruct the difference data Δ between the first data x and the second data x′.

$$Δ ← DiffRec ( s 3 , s 1 ) \qquad ( 20 )$$

The reconstruction function DiffRec may be configured using a difference recovery function DiffRec disclosed in Reference Literature 1. In this case, let a sketch generated using data x and biometric information w be denoted as Gen(x, w), and let a sketch generated using data x+Δ and biometric information w′ be Gen(x+Δ, w′). If a distance d(w, w′) between the two biometric information w and w′ is less than or equal to a predetermined value (e.g., a correction capability t of an error-correcting code), the following holds for the difference reconstruction function DiffRec:

$$DiffRec ( Gen ( x , w ) , Gen ( x + Δ , {w}^{′} ) ) = Δ , if d ( w , {w}^{′} ) \leq t \qquad ( 21 )$$

It is noted that the distance d(w, w′) between two items of biometric information w and w′ may be a Hamming distance, or it may be a Manhattan distance in which bit sequences of w and w′ are each regarded as integer vectors composed of 0 and 1 elements. Alternatively, when the two items of biometric information w and w′ are N-dimensional vectors, the distance d(w, w′) may use any of Manhattan distance (L1 norm), Euclidean distance (L2 norm), Chebyshev distance (L∞ norm), etc.

When the difference recovery function DiffRec in Equation (20) corresponds to the definition in Equation (21), Δ may be constructed as follows, using the decoding function Dec1 corresponding to the encoding function Enc1 that performs error-correction coding.

$$DiffRec ( s 3 , s 1 ) = Dec 1 ( s 1 - s 3 ) \qquad ( 22 )$$

Due to linearity of a linear code, the following holds:

$$s 1 - s 3 = Enc 1 ( x ) + w 1 - ( Enc 1 ( {x}^{′} ) + w {1}^{′} ) = Enc 1 ( x - {x}^{′} ) + ( w 1 - w {1}^{′} ) \qquad ( 23 )$$

When the two items of the biometric information w1 and w1′ are close (i.e., the distance d(w1, w1′) between w1 and w1′ is less than or equal to the error-correction capability t), a result of decoding s1−s3 becomes x−x′.

From Equation (23), the difference recovery function DiffRec(s3, s1) can also be considered operationally equivalent to the recovery function Rec in Equation (4).

$$Δ ← Rec ( s 3 , s 1 ) = Dec 1 ( s 1 - s 3 ) = x - {x}^{′} if d ( w 1 , w {1}^{′} ) \leq t \qquad ( 24 )$$

The operation “−” in Equation (22) and the operations “+” and “−” in Equation (23) may be a bitwise exclusive OR operation.

The sketch management apparatus 120 obtains (receives) the fourth sketch s4 generated by the second sketch generation apparatus 110 (Step 3). The sketch management apparatus 120 then generates a second sketch s2 by combining the fourth sketch s4 and the value Enc2(Δ) which is an encoded value of the difference data Δ by using the error-correcting encoding function Enc2 (Step 4).

$$s 2 ← s 4 + Enc 2 ( Δ ) = Enc 2 ( {x}^{′} ) + w 2 + Enc 2 ( x - {x}^{′} ) \qquad ( 25 )$$

Due to linearity of the encoding function Enc2, the following holds from Equation (25).

$$s 2 = Enc 2 ( {x}^{′} ) + w 2 + Enc 2 ( x - {x}^{′} ) = Enc 2 ( {x}^{′} + ( x - {x}^{′} ) ) + w 2 = Enc 2 ( x ) + w 2 = Gen 2 ( x , w 2 ) \qquad ( 26 )$$

The second sketch s2 is a sketch generated using the first data x used to generate the first sketch s1 and the second biometric information w2.

The sketch management apparatus 120 registers the second sketch s2 in the storage apparatus 130. In FIG. 2, the first sketch s1 and the second sketch s2 are registered under the same user ID (in association with the same ID[1]), but sub-IDs such as ID [1-1] and [1-2] may be assigned to first and second sketches s1 and s2 for management thereof. Alternatively, depending on data management policies, etc., the second sketch s2 may be replaced with a new first sketch s1.

A probability that a value of w can be recovered by an adversary who observes a sketch s is extremely low. According to security property of a secure sketch in Non-Patent Literature 1, a probability that an adversary who observes a secure sketch s can recover a value of W for a distribution W with a minimum entropy m in a metric space M is at most 2\hat{ }(−m), where −m is the residual (min−) entropy and \hat{ }denotes an exponentiation operator. Regarding the first sketch s1, the first data x is embedded as the codeword Enc1(x) into the first biometric information w1. Neither the first data x nor the first biometric information w1 is revealed (remains concealed) from the first sketch s1 in the storage apparatus 130 and the sketch management apparatus 120. Similarly, regarding the third sketch s3, the second data x′ is embedded as the codeword Enc1(x′) into a new first biometric w1′. Both the second data x′ and the new first biometric w1′ are concealed in the sketch management apparatus 120. Regarding the fourth sketch s4, the second data x′ is embedded as the codeword Enc2(x′) into the second biometric information w2. In the sketch management apparatus 120, both the second data x′ and the second biometric information w2 are kept concealed.

In the sketch management apparatus 120, during the generation process of the second sketch s2 from the first sketch s1, the secret first data x and the secret second data x′ only appear, in computation, combined as the difference data (Δ=x−x′), and neither the first data x nor the second data x′ appears, in computation, individually. When the first data x and the second data x′ are used as keys with key lengths of, for example, 256 bits or 1024 bits, it is impossible to recover the original (x, x′) from the difference data Δ=x−x′.

In this manner, it is possible to prevent leakage or compromise of data and biometric information involved in sketch generation. Therefore, it is possible to prevent leakage or compromise of the first data x, which is identified as an issue(s) in the above hypothetical comparative example.

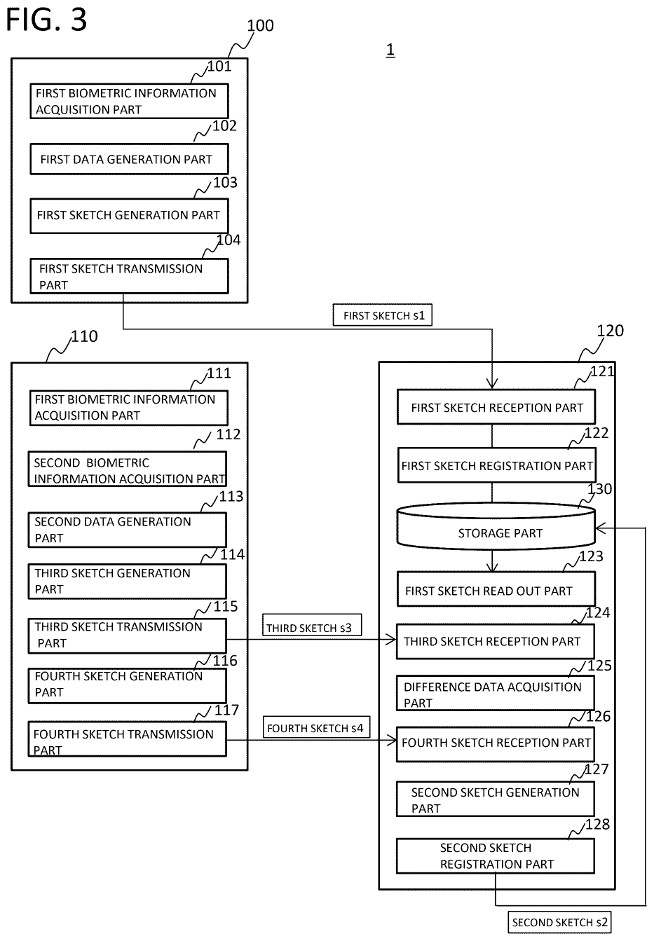

FIG. 3 is a diagram illustrating a functional configuration example of each apparatus included in the system 1 of FIG. 2. Although not particularly limited, FIG. 3 illustrates a configuration example where the storage apparatus 130 of FIG. 2 is provided in the sketch management apparatus 120. The storage apparatus 130 may, as a matter of course, be configured as a separate apparatus (e.g., a database server) distinct from the sketch management apparatus 120. Referring to FIG. 3, the first sketch generation apparatus 100 includes a first biometric information acquisition part 101, a first data generation part 102, a first sketch generation part 103, and a first sketch transmission part 104. The first sketch generation apparatus 100 includes a processor(s), a memory(ies), a communication interface(s), etc. (not shown), and each of the above parts of the first sketch generation apparatus 100 may be implemented by processing (modules) executed by the processor(s). The first biometric information acquisition part 101 extracts features, etc., from the user's biometric information (digital data, etc.) acquired by a sensor (not shown) and generates the first biometric information w1 (digital data). The first data generation part 102 generates the first data x. Although not limited thereto, the first data generation part 102 may use a secret (private) key generated by a key generation algorithm as the first data x. The first sketch generation part 103 generates the first sketch (s1=Enc1(x)+w1). The first sketch transmission part 104 transmits the first sketch s1 to the sketch management apparatus 120 for registration thereof in the storage apparatus 130. At this time, a user ID (identification information) may be transmitted along with the first sketch s1, and the storage apparatus 130 may store and manage the first sketch s1 in association (correspondence) with the user ID. It is noted that while arrows are used in FIG. 3 to represent information transmission, this does not imply unidirectional transmission. It may, of course, include a series of handshakes according to a transmission protocol, such as a transmission request from a sender, an affirmative response (ACK) from a receiver, information transmission from the sender to the receiver, and an affirmative response (or retransmission request) from the receiver. The same applies to the following drawings.

The second sketch generation apparatus 110 includes a first biometric information acquisition part 111, a second biometric information acquisition part 112, a second data generation part 113, a third sketch generation part 114, a third sketch transmission part 115, a fourth sketch generation part 116, and a fourth sketch transmission part 117. The second sketch generation apparatus 110 may include a processor(s), a memory(ies), a communication interface(s), etc. (not shown). Each of the above parts of the second sketch generation apparatus 110 may be implemented by processing (modules) executed by the processor(s).

The first biometric acquisition part 111 acquires anew first biometric information w1′ with a modality, a body part, and a user all identical to those of the first biometric information w1 used to generate the first sketch s1 and registered in advance in the storage apparatus 130. The first biometric information acquisition part 111 may be identical to the first biometric information acquisition part 101 of the first sketch generation apparatus 100. For example, when the first sketch generation apparatus 100 and the second sketch generation apparatus 110 are configured as a single apparatus, the first biometric information acquisition part 111 and the first biometric information acquisition part 101 may be shared.

The second biometric acquisition part 112 acquires the second biometric information w2. The second biometric information w2 may be acquired from the same user as the first biometric information w1 used to generate the first sketch s1, but may have a different modality (e.g., the first biometric information w1 and the new first biometric information w1′ may be iris information, while the second biometric information w2 may be finger vein information, etc.). As described later, the second biometric information w2 may be biometric information from a different body part, provided the second biometric information w2 shares the same user and modality as the first biometric information w1. The second data generation part 113 generates the second data x′ (e.g., an integer chosen uniformly at random). The third sketch generation part 114 generates a third sketch s3 using the second data x′ and the first biometric information w1′ (s3=Enc1(x′)+w1′). The third sketch transmission part 115 transmits the third sketch s3 to the sketch management apparatus 120. The fourth sketch generation part 116 generates a fourth sketch s4 using the second data x′ and the second biometric information w2 (s4=Enc(x′)+w2). The fourth sketch transmission part 117 transmits the fourth sketch s4 to the sketch management apparatus 120. It is noted that the third sketch s3 and the fourth sketch s4 may be transmitted together to the sketch management apparatus 120.

The sketch management apparatus 120 includes a first sketch reception part 121, a first sketch registration part 122, a storage apparatus 130, a first sketch read out part 123, a third sketch reception part 124, a difference data acquisition part 125, a fourth sketch reception part 126, a second sketch generation part 127, and a second sketch registration part 128. The sketch management apparatus 120 may include a processor(s), a memory(ies), a communication interface(s), etc. (not shown), and each of the above parts of the sketch management apparatus 120 may be implemented by processing (modules) executed by the processor(s).

The first sketch reception part 121 receives the first sketch s1 generated and transmitted by the first sketch generation apparatus 100. The first sketch registration part 122 registers the first sketch s1 received in the storage apparatus 130. The first sketch registration part 122 may store the first sketch s1, for example, in association with a user ID. The first sketch read out part 123 reads a first sketch s1 from the storage apparatus 130. The third sketch reception part 124 receives the third sketch s3 transmitted from the second sketch generation apparatus 110. The third sketch reception part 124 receives the user ID transmitted along with the third sketch s3 sent from the second sketch generation apparatus 110. The first sketch read out part 123 may be configured to read the first sketch s1 corresponding to the user ID transmitted from the storage apparatus 130, thereby acquiring the first sketch s1 corresponding to the third sketch s3.

The difference data acquisition part 125 restores difference data Δ(=Dec (s1−s3)=x−x′) based on the first sketch s1 and the third sketch s3. The fourth sketch reception part 126 receives the fourth sketch s4 transmitted from the second sketch generation apparatus 110. The second sketch generation part 127 generates the second sketch s2 (=Enc(x)+w2) by combining the fourth sketch s4 and the difference data Δ (=x−x′). The second sketch registration part 128 registers the second sketch s2 in the storage apparatus 130.

The first data x used to generate the first sketch s1 is not revealed in the second sketch generation apparatus 110 nor in the sketch management apparatus 120.

The above describes an example where the second biometric information w2 has a different modality from the first biometric information w1 (and the new first biometric information w1′), and where a sensor for sensing the first biometric acquisition part 101 (111) and a sensor for sensing the second biometric acquisition part 112 are different. However, a user and a modality of the second biometric information w2 may be the same as the first biometric information w1 (and the new first biometric information w1′), but be acquired from a different body part (e.g., the first biometric information w1 is finger vein information from an index finger of the user and the second biometric information w2 is of the same modality (finger vein information) as the first biometric information w1, but is finger vein information from a middle finger of the same user). In this case, a sensor acquiring the first biometric information w1 (and the new first biometric information w1′) and a sensor acquiring the second biometric information w2 may be the same (one sensor, or the same type or model), and the encoding functions Enc1 and Enc2 may be the same. Alternatively, the first biometric information w1 may be finger vein information from the index finger, while the second biometric information w2 may be finger vein information from two fingers (index and middle) or three fingers (index, middle, and ring). In this case, the sensor acquiring the first biometric information w1 (and the new first biometric information w1′) and the sensor acquiring the second biometric information w2 may differ in configuration or model, and the data formats of the first biometric information w1 and the second biometric information w2 may also differ.

Furthermore, if a length of the first biometric information w1 is C bits (blocks), and a codeword length of the encoding function Enc1 is n bits (blocks) with n<C, then (C−n) bits (blocks) may be added to the n-bit (block) codeword, for example, using random numbers (pseudorandom numbers) over a two-element field F2, to form C bits (blocks), which may then be combined with the first biometric information w1. The same applies to the encoding function Enc2. (Reference Literature 3).

The following describes a non-limiting example of sketch generation where the first biometric information w1 or the second biometric information w2 is represented as a feature vector (an N-dimensional feature vector) extracted from a face image, etc. When expanding the first data x, which is a scalar value (integer), into, for example, an N-dimensional vector, an encoding function using a square lattice may be used (e.g., Reference Literature 4). The first biometric information w1 and the new first biometric information w1′ are N-dimensional real value vectors.

$$w 1 = ( w {1}_{1} , \text{…} , w {1}_{N} ) , w {1}^{′} = ( w {1}_{1}^{′} , \text{…} , w {1}_{N}^{′} ) \qquad ( 27 )$$

A distance between the first biometric information w1 and the new first biometric information w1′ may be defined using, for example, the L^{∞} norm (maximum value norm)

$${d}_{∞}^{( n )} ( w 1 - w {1}^{′} ) = max \{ \vert w 1 i - w {1}^{′} i \vert , i = 1 , … , N \qquad ( 28 )$$

If the distance

$${d}_{∞}^{( n )} ( w 1 , w {1}^{′} )$$

is less than or equal to a predetermined threshold threshold tₕ

$$( {d}_{∞}^{( n )} ( w 1 , w {1}^{′} ) \leq {t}_{h} ) ,$$

they are considered to match (same biometric).

Let Y be an n-dimensional integer vector, and define the lattice point set L as follows:
L={Y=(y1, . . . , yn)|yi is a non-negative integer,

$$0 ≦ y i ≦ K \} \qquad ( 29 )$$

where K is a predetermined integer sufficiently larger than a threshold tₕ or |wi|.

The function int( ) that maps an integer z to an N-dimensional integer vector Y∈L is defined as follows:

$$z ← int ( Y ) = {\sum }_{i = 1}^{N} {{y}_{i} ( 2 K )}^{i - 1} \qquad ( 30 )$$

The inverse function of int, int⁻¹( ), maps an integer z to an N-dimensional integer vector Y.

$$Y ← {int}^{- 1} ( z ) \qquad ( 31 )$$

When the first data x (an integer) is inputted into the inverse function int⁻¹( ), the N-dimensional integer vector A is obtained.

$$A = ( a 1 , … , aN ) ← {int}^{- 1} ( x ) \qquad ( 32 )$$

In Equation (32), an integer value is assigned to each lattice point, and the inverse function int⁻¹(x) maps the first data x (an integer) to the lattice point in the integer lattice that corresponds to the N-dimensional integer vector A.

Using the inverse function int⁻¹( ) of Equation (32), the encoding function Enc1( ) is defined as 2tₕ*int⁻¹( ). A codeword c which is an encoded value of the first data x is an N-dimensional vector given as below.

$$c = ( {c}_{1} , … , {c}_{N} ) ← Enc 1 ( x ) = 2 {t}_{h} * ← {int}^{- 1} ( x ) = 2 {t}_{h} * ( {a}_{1} , … , {a}_{N} ) \qquad ( 33 )$$

Therefore, the first sketch s₁ is given by:

$$s 1 = Enc 1 ( x ) + w 1 = 2 {t}_{h} * ( {a}_{1} , … , {a}_{N} ) + ( w {1}_{1} , … , w {1}_{N} ) = ( 2 {t}_{h} * {a}_{1} + w {1}_{1} , … , 2 {t}_{h} * {a}_{N} + w {1}_{N} ) \qquad ( 34 )$$

Regarding the third sketch s3 generated using the new first biometric information w1′ and the second data x′, when using a square lattice for encoding as below, with the first sketch s1:

$${c}^{′} = ( {c}_{1}^{′} , … , {c}_{N}^{′} ) ← Enc 1 ( Δ ) = 2 {t}_{h} * {int}^{- 1} ( {x}^{′} ) = 2 th * ( {a}_{1} , … , {a}_{N} ) \qquad ( 35 )$$

the third sketch s3 is computed as the following N-dimensional vector:

$$s 3 = 2 {t}_{h} * {int}^{- 1} ( {x}^{′} ) + w {1}^{′} = 2 {t}_{h} * ( {a}_{1}^{′} , … , {a}_{N}^{′} ) + ( w {1}_{1}^{′} , … , w {1}_{N}^{′} ) = ( 2 {t}_{h} * {a}_{1}^{′} + w {1}_{1}^{′} , … , 2 {t}_{h} * {a}_{N}^{′} + w {1}_{N}^{′} ) \qquad ( 36 )$$

The difference data between the first sketch s1 and the third sketch s3 is given by:

$$s 1 - s 3 = Enc 1 ( x ) - Enc 1 ( {x}^{′} ) + ( w {1}_{1} , … , w {1}_{N} ) - ( w {1}_{1}^{′} , … , w {1}_{N}^{′} ) = Enc 1 ( x - {x}^{′} ) + ( w {1}_{1} - w {1}_{1}^{′} , … , w {1}_{N} - w {1}_{N}^{′} ) \qquad ( 37 )$$

When the encoding function Enc1 uses the above 2tₕ*int⁻¹( ), the decoding function Dec1 may be defined as:

$$Dec 1 ( c ) = int ( c / 2 {t}_{h} ) \qquad ( 38 )$$

$$\begin{matrix}Δ ← Dec 1 ( s 1 - s 3 ) & = [ \frac{1}{2 {t}_{h}} \{ ( w 1 + 2 {t}_{h} * {int}^{- 1} ( x ) ) - ( w {1}^{′} + 2 {t}_{h} * {int}^{- 1} ( {x}^{′} ) ) \} ] \\ & = int \{ {int}^{- 1} ( x - {x}^{′} ) + \frac{1}{2 {t}_{h}} ( w 1 - w {1}^{′} ) \} \\ & = int \{ {int}^{- 1} ( x - {x}^{′} ) + \frac{1}{2 {t}_{h}} ( w {1}_{1} - w {1}_{1}^{′} , ⋯ , w {1}_{N} - w {1}_{N} \}\end{matrix} \qquad ( 39 )$$

When the first biometric information w1 and the new first biometric information w1′ are close and the distance

$${d}_{∞}^{( n )}$$

therebetween is less than or equal to the threshold value th,

$${d}_{∞}^{( n )} ( w , {w}^{′} ) = max \{ \vert {w}_{i} - {{w}^{′}}_{i} \vert , i = 1 , … , n \} <= {t}_{h} \qquad ( 40 )$$

an absolute value of each component of the n-dimensional vector (w−w′)/2tₕ in Equation (39) is less than equal to ½.

Therefore, Equation (39) becomes:

$$Δ ← Dec 1 ( s 1 - s 3 ) = int ( {int}^{- 1} ( x - {x}^{′} ) ) = x - {x}^{′} \qquad ( 41 )$$

In the above-described example embodiment, the second sketch s2 is generated based on the first sketch s1 using the second biometric information w2 with a different modality from the first biometric w1 used to generate the registered first sketch s1. However, it is possible for the example embodiment to be applied to updating a first sketch s1 registered in advance by acquiring anew first biometric information w1,′ a user, modality and body part of which are all the same as those of the first sketch s1 registered in advance. In biometric authentication, periodic updating of a registered biometric template is recommended. Similarly, in a biometric cryptographic scheme utilizing biometric information, updating a sketch is also recommended. For example, it is known that in facial recognition and similar technologies, accuracy for recognition varies depending on conditions, due to technological characteristics. Therefore, considering factors such as facial expression, facial feature, hairstyle, aging, lighting condition, etc., periodic updating (e.g., approximately every few years) of a registered facial image may be desirable. The following describes an example of updating the first biometric information w1 used to generate the first sketch s1 and registered in advance using the new first biometric information w1′.

In this case, as shown in FIG. 2, generating the fourth sketch s4 is unnecessary. The second sketch s2 is generated based on the third sketch s3 and the difference data Δ (computed by Equation (24)) without revealing the first data x.

$$s 2 ← s 3 + Enc 1 ( Δ ) = Enc 1 ( {x}^{′} ) + w {1}^{′} + Enc 1 ( x - {x}^{′} ) = Enc 1 ( {x}^{′} + ( x - {x}^{′} ) ) + w {1}^{′} = Enc 1 ( x ) + w {1}^{′} \qquad ( 42 )$$

When the first biometric information w1 is facial information, significant changes in facial features may occur with developmental stages in infants, children, etc. Therefore, an update period for the first sketch s1 may be set to, for example, approximately one year though not limited thereto. Alternatively, user information such as age may be registered in association with a user ID for the first sketch s1 stored in the memory apparatus 130. Considering factors like age and the update period for the first sketch s1, the threshold t for the distance d(w1, w1′) between the first biometric information w1 and the new first biometric information w1′ in Equation (24) may be appropriately relaxed for infants, children, etc. For adults, however, the update period for the first sketch s1 may be set approximately even to five years (or even longer).

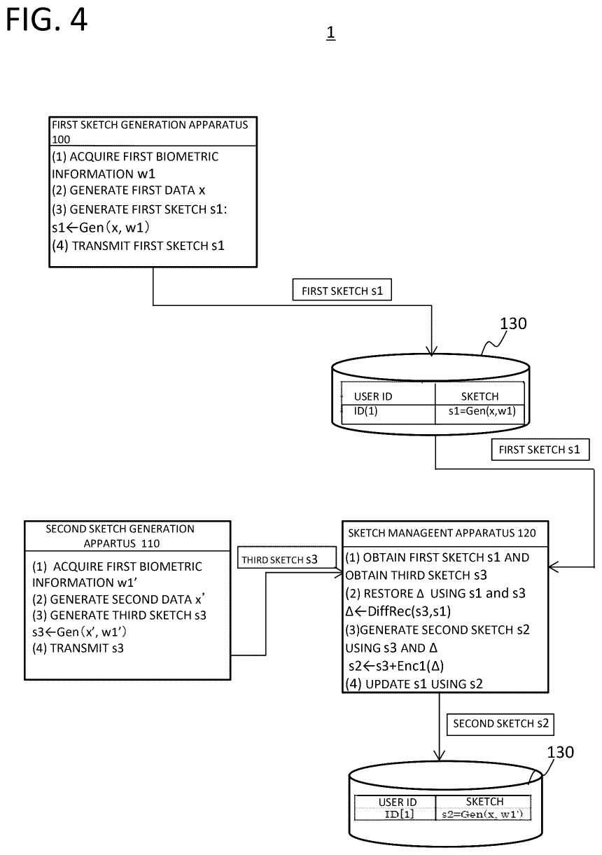

FIG. 4 illustrates an example embodiment. The first sketch generation apparatus 100 transmits the first sketch s1 and registers it in the storage apparatus 130. Since the first sketch generation apparatus 100 has the same configuration as the first sketch generation apparatus 100 in FIG. 2, the description thereof is omitted.

The second sketch generation apparatus 110 acquires the new first biometric information w1′ of a user (Step 1), generates the second data x′ (Step 2), and generates the third sketch s3 (Step 3). For example, the second sketch generation apparatus 110 may obtain third sketch s3 by combining the value Enc1(x′) obtained by error-correcting encoding of the second data x′ using the encoding function Enc1 and the new first biometric information w1′.

$$s 3 ← Gen ( {x}^{′} , w {1}^{′} ) = Enc 1 ( {x}^{′} ) + w {1}^{′} \qquad ( 43 )$$

The sketch management apparatus 120 obtains the first sketch s1 registered in the storage apparatus 130 and the third sketch s3 generated and transmitted by the sketch generation apparatus 110 (Step 1). The sketch management apparatus 120 restores the difference data Δ based on the first sketch s1 and the third sketch s3 (Step 2).

$$Δ ← Dec 1 ( s 1 - s 3 ) = Dec 1 ( Enc 1 ( x - {x}^{′} ) + w 1 - w {1}^{′} ) = x - {x}^{′} , \qquad ( 44 )$$

$$if d ( w 1 , w {1}^{′} ) \leq t$$

where t is an error-correction capability of the error correcting coding.

The sketch management apparatus 120 generates the second sketch s2 by combining the third sketch s3 and Enc1(Δ) which is an encoded value of the difference data Δ encoded by the error-correcting encoding function Enc1.

$$s 2 ← s 3 + Enc 1 ( Δ ) = Enc 1 ( {x}^{′} ) + w {1}^{′} + Enc 1 ( x - {x}^{′} ) = Enc 1 ( x ) + w {1}^{′} = Gen ( x , w {1}^{′} ) \qquad ( 45 )$$

The sketch management apparatus 120 updates the first sketch s1 registered in advance in the storage apparatus 130, by using the generated second sketch s2. More specifically, the sketch management apparatus 120 replaces the first sketch s1 registered in the storage apparatus 130 with the second sketch s2. In this example as well, during the generation process of the second sketch s2, the first data x is never revealed, which ensures that leakage of the first data x can be avoided when generating the second sketch s2 from the first sketch s1.

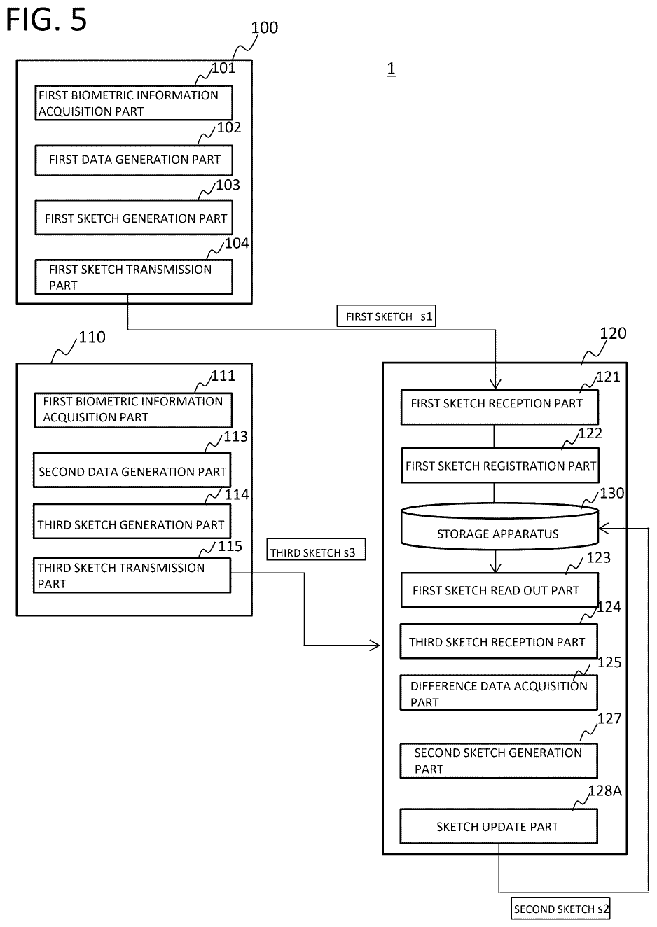

FIG. 5 is an example diagram illustrating a functional configuration of each apparatus included in the system 1 of FIG. 4. Referring to FIG. 5, the first sketch generation apparatus 100 is identical to the apparatus 10 in FIG. 3. The second sketch generation apparatus 110 has the second biometric information acquisition part 112, the fourth sketch generation part 116, and the fourth sketch transmission part 117 removed from the second sketch generation apparatus 110 in FIG. 3. The sketch management apparatus 120 has the fourth sketch reception part 126 removed from the sketch management apparatus 120 of FIG. 3 and includes a sketch update part 128A in place of the second sketch registration part 128. The sketch update part 128A replaces (overwrites) the first sketch s1 for the corresponding user ID in the storage apparatus 130 with the second sketch s2 generated by the second sketch generation part 127. In FIG. 5, other parts of the sketch management apparatus 120 are the same as the corresponding parts of the sketch management apparatus 120 in FIG. 3, therefore, the description thereof is omitted.

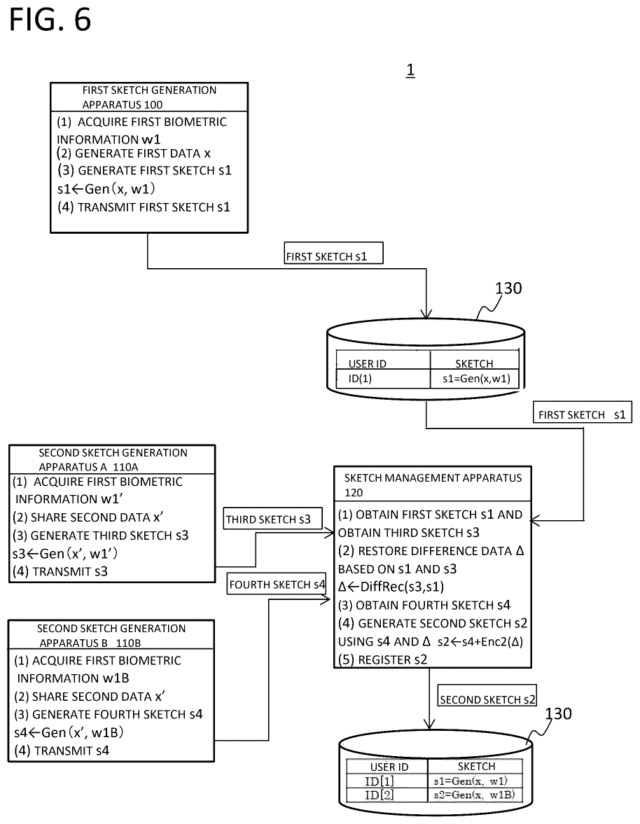

FIG. 6 illustrates a further example embodiment. In this example embodiment, a second sketch s2 (=Enc1(x)+w1B) is generated from a registered first sketch s1 of User A (=Enc1(x)+w1), by using first biometric information w1B of User B (same modality as User A's first biometric information w1) and the first data x. Since the second sketch s2 is generated using first biometric information w1B of User B, when the second sketch s2 is used for biometric authentication, authentication of User B is performed. When a signature for a document is to be generated using the second sketch s2, verification of the signature is performed using a verification key (public key) corresponding to a secret (private) key (e.g., the first data x) of User A. This procedure may correspond to such a scenario that User B can generate a signature as User A, which, for example, corresponds to a case where User B is a granted specific authority to act on behalf of User A, such as being a family member or an agent of User A.

The description of generation and registration of the first sketch s1 by the first sketch generation apparatus 100 is omitted. It is noted that the first sketch s1 registered in the storage apparatus 130 is assumed to have been created using the first biometric information w1 of User A and the first data x, which is secret information of User A.

The second sketch generation apparatus A (110A) acquires anew first biometric information w1′ of User A (Step 1).

The second sketch generation apparatus A (110A) securely shares the second data x′ with the second sketch generation apparatus B (110B) via key exchange or similar means, such as key sharing (Step 2).

The second sketch generation apparatus A (110A) generates the third sketch s3 (Step 3). For example, the second sketch generation apparatus A obtains the third sketch s3 by combining a value Enc1(x′) (obtained by error-correcting coding the second data x′ using an encoding function Enc1) and the new first biometric information w1′.

$$s 3 ← Gen ( {x}^{′} , w {1}^{′} ) = Enc 1 ( {x}^{′} ) + w {1}^{′} \qquad ( 46 )$$

The second sketch generation apparatus A (110A) transmits the third sketch s3 to the sketch management apparatus 120 (Step 4). The second sketch generation apparatus A (110A) may be a terminal of User A. Alternatively, the second sketch generation apparatus A (110A) may be a terminal installed at a store or facility.

The second sketch generation apparatus B (110B) acquires the first biometric information w1B (same modality as the first biometric information w1) of User B (Step 1).

The second sketch generation apparatus B (110B) securely shares second data x′ with the second sketch generation apparatus A (110A) via key exchange or similar means. For example, the second sketch generation apparatus B may perform DH (Diffie-Hellman) key exchange (Step 2).

The second sketch generation apparatus B (110B) generates the fourth sketch s4 (Step 3). For example, the second sketch generation apparatus B may obtain the fourth sketch s4 by combining the value Enc1(x′), which is an encoded value of the second data x′ using the error-correcting encoding function Enc1, and the first biometric information w1B of User B.

$$s 4 ← Gen ( {x}^{′} , w 1 B ) = Enc 1 ( {x}^{′} ) + w 1 B \qquad ( 47 )$$

The second sketch generation apparatus B (110B) transmits the fourth sketch s4 to the sketch management apparatus 120 (Step 4). The second sketch generation apparatus B (110B) may be a terminal (smartphone) of User B. Alternatively, it may be a terminal installed at a store or facility. It is noted that in FIG. 6, the second sketch generation apparatus B (110B) and the second sketch generation apparatus A (110A) are configured as separate apparatuses. However, the second sketch generation apparatus B (110B) may be the same apparatus as the second sketch generation apparatus A (110A). This corresponds, for example, to a situation where User B holds his/her biometric (corresponding to first biometric information w1B) to a terminal of User A (second sketch generation apparatus A (110A)) at a location where User A is present.

In Step 2 of both the second sketch generation apparatus A (110A) and the second sketch generation apparatus B (110B), for example, the secret keys a and b and the public keys A (=g\hat{ }a mod p) and B (=g\hat{ }b mod p) (where p is a prime number and g is a generator of a multiplicative group of a finite field F*ₚ, whose order is a prime q (a divisor of (p−1))) are generated, their respective public keys A and B, are exchanged, and B\hat{ }a mod p and A\hat{ }b mod p are computed using their own secret keys (a and b) and the received public keys (B and A) to generate and hold a shared key (g\hat{ }ab mod p), as the second data x′.

In FIG. 6, if the second sketch generation apparatus B (110B) and the second sketch generation apparatus A (110A) are to be made as one apparatus, the above-described key sharing is not required, as in FIG. 2.

The sketch management apparatus 120 acquires the first sketch s1 registered in the storage apparatus 130 and the third sketch s3 generated by the second sketch generation apparatus A (110A) (Step 1), and restores the difference data Δ from the first sketch s1 and the third sketch s3 (Step 2).

$$Δ ← Dec 1 ( s 1 - s 3 ) = Dec ( Enc 1 ( x - {x}^{′} ) + w 1 - w {1}^{′} ) = x - {x}^{′} , \qquad ( 48 )$$

$$if d ( w 1 , w {1}^{′} ) \leq t$$

The sketch management apparatus 120 acquires the fourth sketch s4 generated by the second sketch generation apparatus B (110B) (Step 3), and generates the second sketch s2 by combining the fourth sketch s4 and the codeword Enc1(Δ) obtained by encoding the difference data Δ using the error-correcting encoding function Enc1 (Step 4).

$$s 2 ← s 4 + Enc 1 ( Δ ) = Enc 1 ( {x}^{′} ) + w 1 B + Enc 1 ( x - {x}^{′} ) = Enc 1 ( {x}^{′} + ( x - {x}^{′} ) ) + w 1 B = Enc 1 ( x ) + w 1 B = Gen ( x , w 1 B ) \qquad ( 49 )$$

The sketch management apparatus 120 may register the second sketch s2 in the storage apparatus 130 as a sketch for User B (ID[2]). In this case, the storage apparatus 130 registers the first sketch s1 and the second sketch s2 corresponding to the user IDs (ID[1], ID[2]) of users A and B, respectively. According to the present embodiment, the second sketch s2 can be generated from the first sketch s1, which was generated using the first data x (e.g., secret information of User A) and the first biometric information w1, using the first data x and User B's first biometric information w1B. In this case, the first data x (e.g., secret information of User A) is not revealed to User B's second sketch generation apparatus B (110B) or the sketch management apparatus 120. It is noted that if the second sketch generation apparatus A (110A) and the second sketch generation apparatus B (110B) are integrated into one apparatus, the sketch management apparatus 120 may register the second sketch s2 (=Gen(x, w1B)) generated using the fourth sketch s4 transmitted from the second sketch generation apparatus A (110A) and the difference data Δ in the storage apparatus 130 using the user ID of User A.

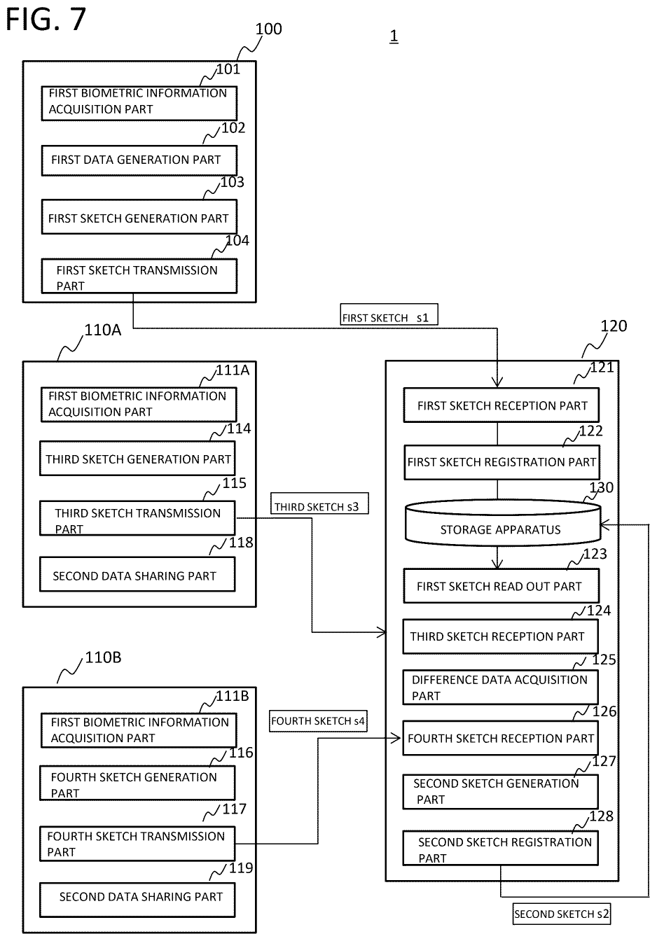

FIG. 7 is a diagram illustrating a functional configuration example of each apparatus included in the system 1 of FIG. 6. Referring to FIG. 7, the second sketch generation apparatus A (110A) includes a first biometric information acquisition part 111A, a third sketch generation part 114, a third sketch transmission part 115, and a second data sharing part 118. The second sketch generation apparatus B (110B) includes a first biometric information acquisition part 111B, a fourth sketch generation part 116, a fourth sketch transmission part 117, and a second data sharing part 119. A sensor of the first biometric information acquisition part 111A of the second sketch generation apparatus A (110A) and a sensor of the first biometric information acquisition part 111B of the second sketch generation apparatus B (110B) are of the same model (type, performance). The second data sharing part 118 of the second sketch generation apparatus A (110A) and the second data sharing part 119 of the second sketch generation apparatus B (110B) may share the second data x′, which is confidential information, according to the above-described DH key sharing, etc. The first sketch generation apparatus 100 and the second sketch generation apparatus A (110A) may be configured as a single apparatus, for example, as a terminal apparatus for User A.

As described above, when the second sketch generation apparatus B (110B) has the same apparatus (integrated) as the second sketch configuration generation apparatus A (110A), in FIG. 7, the second data sharing part 118 of the second sketch generation apparatus A (110A) is replaced with the second data generation part 113 of FIG. 3, then the fourth sketch generation part 116 and the fourth sketch transmission part 117 of the second sketch generation apparatus B (110B) can be implemented within the second sketch generation apparatus A (110A), and the second sketch generation apparatus B (110B) can be removed.

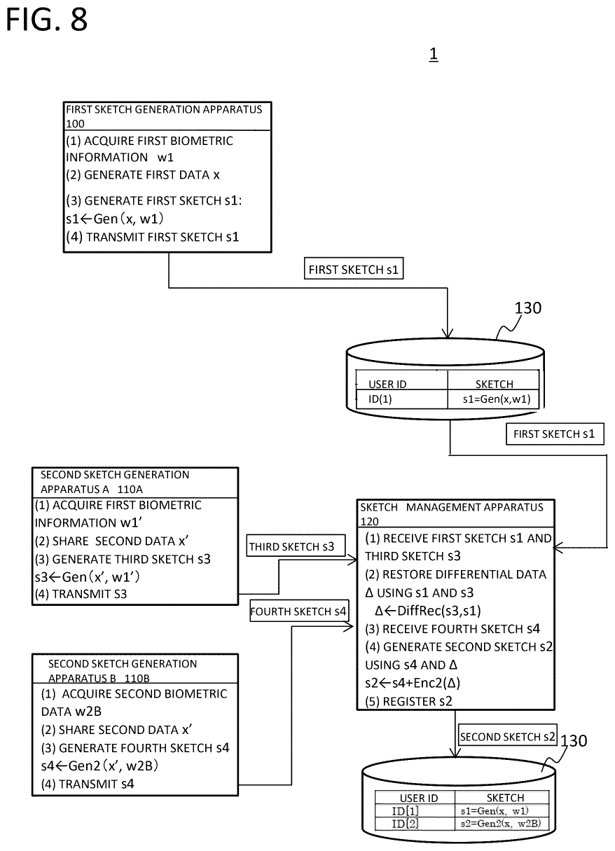

In the example of FIG. 6, a second sketch s2 (=Enc2(x)+w1B) is generated from the registered first sketch s1 for User A (=Enc1(x)+w1) using the first biometric information w1B of User B (same modality and body part as w1) and the first data x. However, from the registered first sketch s1 for User A (=Enc1(x)+w1) to generate a second sketch s2 (=Enc2(x)+w2B) using the second biometric information w2B of User B (which has a modality different from that of w1) and the first data x. FIG. 8 illustrates this example. The procedure for generating the first sketch s1 by the first sketch generator 100 and the procedure for generating the third sketch s3 by the second sketch generation apparatus A (110A) in FIG. 8 are identical to those in FIG. 6, and thus the description thereof is omitted.

The second sketch generation apparatus B (110B) acquires the second biometric information w2B of User B (Step 1).

The second sketch generation apparatus B (110B) securely shares the second data x′ with the second sketch generation apparatus A (110A) via key sharing or similar means. As described above, this sharing may be performed using, for example, DH (Diffie-Hellman) key sharing (Step 2).

The second sketch generation apparatus B (110B) generates the fourth sketch s4 (Step 3). For example, the second sketch generation apparatus B (110B) obtains the fourth sketch s4 by combining the value Enc2(x′), which is an encoded value of the second data x′ using the error-correcting encoding function Enc2, and the second biometric information w2B of User B.

$$s 4 ← Gen ( {x}^{′} , w 2 B ) = Enc 2 ( {x}^{′} ) + w 2 B \qquad ( 50 )$$

The second sketch generation apparatus B (110B) transmits the fourth sketch s4 to the sketch management apparatus 120 (Step 4).

The sketch management apparatus 120 acquires the first sketch s1 registered in the storage apparatus 130 and the third sketch s3 generated by the second sketch generation apparatus A 110A (Step 1), and restores the difference data Δ from the first sketch s1 and the third sketch s3 (Step 2).

$$Δ ← Dec 1 ( s 1 - s 3 ) = Dec 1 ( Enc 1 ( x - {x}^{′} ) + w 1 - w {1}^{′} ) = x - {x}^{′} , \qquad ( 51 )$$

$$if d ( w 1 , w {1}^{′} ) \leq t$$

The sketch management apparatus 120 acquires the fourth sketch s4 generated by the second sketch generation apparatus B (110B) (Step 3), and generates the second sketch s2 using the fourth sketch s4 (=Enc2(x′)+w2B) and the value Enc2(Δ) obtained by error-correcting encoding the difference data Δ using the encoding function Enc2(Step 4).

$$s 2 ← s 4 + Enc 2 ( Δ ) = Enc 2 ( {x}^{′} ) + w 2 B + Enc 2 ( x - {x}^{′} ) = Enc 2 ( {x}^{′} + ( x - {x}^{′} ) ) + w 2 B = Enc 2 ( x ) + w 2 B = Gen 2 ( x , w 2 B ) \qquad ( 52 )$$

The sketch management apparatus 120 registers the second sketch s2 as a sketch for User B (ID[2]) in the storage apparatus 130.

In FIG. 8, the second sketch generation apparatus B (110B) and the second sketch generation apparatus A (110A) are configured as separate apparatuses. However, the second sketch generation apparatus B (110B) may be the same apparatus as the second sketch generation apparatus A (110A). That is, in a case where the terminal of User A (the second sketch generation apparatus A (110A) that acquires the user's new first biometric information w1′ and generates the third sketch s3) includes the second biometric information acquisition part 112 (sensor), the second data generation part 113, the fourth sketch generation part 116, and the fourth sketch transmission part 117, each shown in FIG. 3, User B may hold his/her biometric (corresponding to the second biometric information w2B) to the second biometric information acquisition part 112 (a sensor) of the second sketch generation apparatus A (110A), as a result of which the second biometric information w2B of User B may be acquired and the fourth sketch s4 may generated. The second sketch generation apparatus A (110A) may be a terminal installed at a facility or store, etc., in place of the terminal of User A. In this case, the second data sharing part 118 of the second sketch generation apparatus A (110A) is not required (DH key sharing, etc., is not required). It is noted that, when the second sketch generation apparatus A (110A) and the second sketch generation apparatus B (110B) are integrated into one apparatus, the sketch management apparatus 120 may register the second sketch s2 (=Gen2(x, w2B)) generated using the fourth sketch s4 transmitted from the second sketch generation apparatus A (110A) and the difference data Δ in the storage apparatus 130 using the user ID of User A. Alternatively, when the second sketch generation apparatus A (110A) transmits the fourth sketch s4 to the sketch management apparatus 120, the second sketch generation apparatus A (110A) may also transmit the user ID of User B, thereby registering the second sketch s2 (=Gen2(x, w2B)) in the storage apparatus 130 using the user ID of User B.

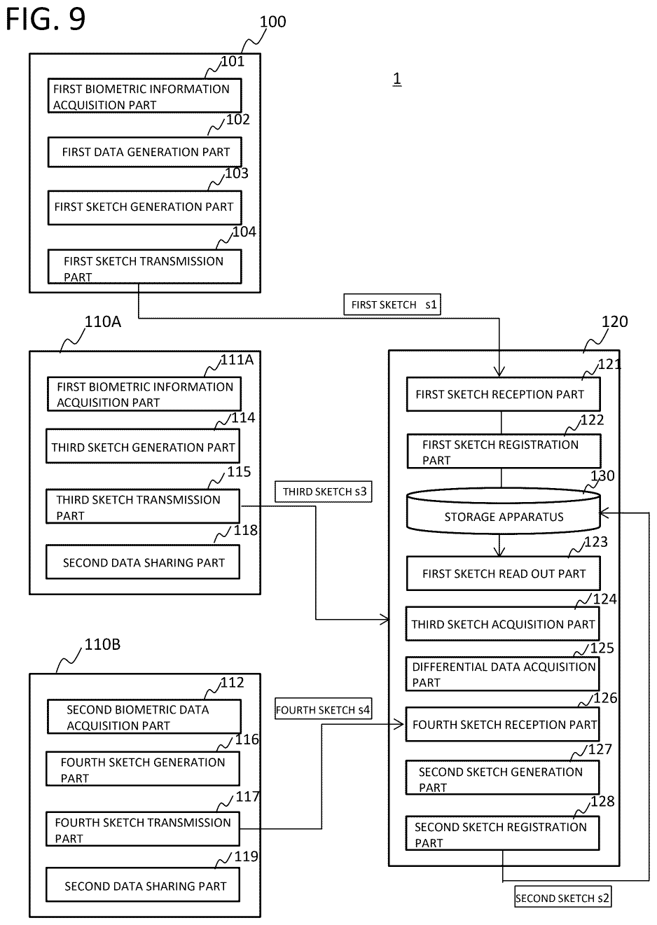

FIG. 9 is a diagram illustrating a functional configuration example of each apparatus included in the system of FIG. 8. In FIG. 9, the first sketch generation apparatus 100 and the second sketch generation apparatus A (110A) are identical to the first sketch generation apparatus 100 and the second sketch generation apparatus A (110A) of FIG. 7. In FIG. 9, the second biometric information acquisition part 112 of the second sketch generation apparatus B (110B) acquires the second biometric information w2B of User B. The fourth sketch generation part 116 of the second sketch generation apparatus B (110B) generates a fourth sketch s4 (=Enc2(x′)+w2B) using the encoding function Enc2. The second sketch generation part 127 of the sketch management apparatus 120 combines the value Enc2(Δ), which is an encoded value of the difference data acquired by the difference data acquisition part 125 using the error-correcting encoding function Enc2, and the fourth sketch s4 (=Enc2(x′)+w2B) to generate the second sketch s2 (=Enc2(x)+w2B). It is noted that if the second sketch generation apparatus B (110B) is the same apparatus as the second sketch generation apparatus A (110A), the second sketch generation apparatus A (110A) may be configured, for example, as the second sketch generation apparatus 110 in FIG. 3.

In the above example, adding or updating of the sketch s2 is done based on the first sketch s1 registered in the storage apparatus 130. However, it is also possible to generate a biometric signature, etc., using the second sketch s2 registered as a template in the storage apparatus 130. For example, the second sketch generation apparatus 110 in FIG. 2 may newly acquire the second biometric information w2′, newly generate the second data x′″, acquire a message M to be signed, generate a first distributed signature using the newly generated second data x″ as a signing key for the message M, generate a new third sketch s3′ using the newly generated second data x″ and the newly acquired second biometric information w2′, and transmit the new third sketch s3′ to the sketch management apparatus 120. The sketch management apparatus 120 inputs the second sketch s2 registered as a template and the new third sketch s3′ into the difference recovery function DiffRec to generate the difference data Δ (=DiffRec(s3′, s2)=x−x″) between the first data x and the new second data x″, generates a second distributed signature for the message M using the difference data Δ as the signing key. The second sketch generation apparatus 110 obtains the second distributed signature from the sketch management apparatus 120 and combines the first distributed signature generated with the first data x and the second distributed signature generated with the difference key Δ (=x−x′) to generate a signature equivalent to one for the message M generated with the first data x as a signing key. Alternatively, for the second distributed signature o′ generated using the difference data Δ (=x−x′) as a signing key, a key homomorphic function Khom (corresponding to Sign Shift in Reference 5, or partially corresponding to the Adapt algorithm in Reference 6) may be applied:

$$σ ← Khom ( {x}^{′} , {σ}^{′} ) \qquad ( 53 )$$

to generate a signature σ equivalent to that generated using the first data x as the signing key, where Δ+x′=(x−x′)+x′=x. In a verification apparatus (not shown), the verification key vk corresponding to the first data x (signing key) may be used to verify correctness of a set of the message M and the signature σ (Verify (vk, σ, M)).

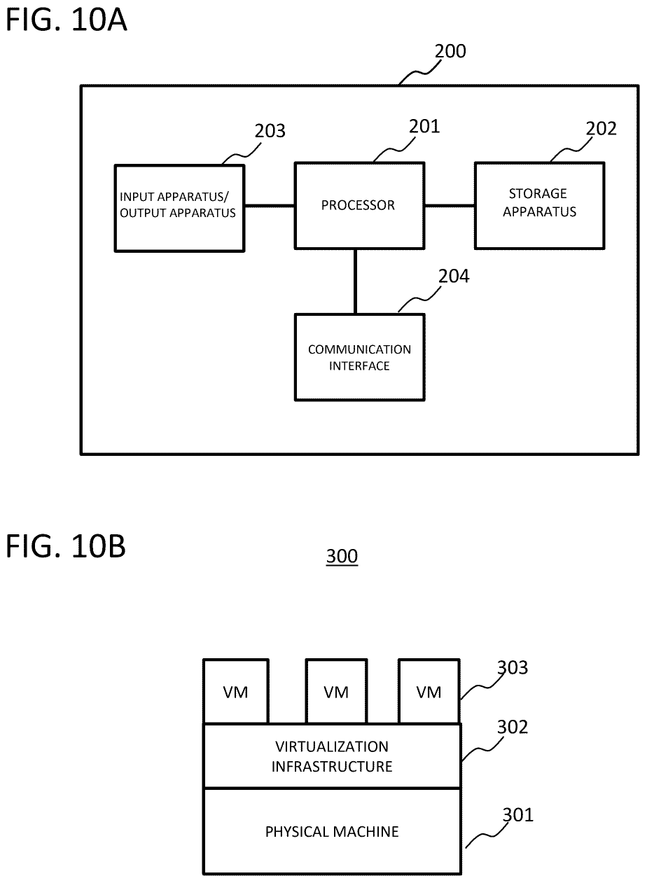

FIG. 10A is a schematic diagram illustrating an example where the apparatuses of the system 1 are implemented by computers 200 equipped with communication functions and capable of communicating with each other via a network. Referring to FIG. 10A, the apparatuses (100, 110, 120) of FIG. 3 may each include a processor 201 (which may be plural), a storage apparatus 202, an input/output apparatus 203, and a communication interface 204. The storage apparatus 202 may be configured with a semiconductor storage such as RAM (Random Access Memory), ROM (Read Only Memory), or EEPROM (Electrically Erasable and Programmable ROM), or with HDD (Hard Disk Drive), CD (Compact Disc), DVD (Digital Versatile Disc), etc. The processor 201 is configured to execute a program (not shown) stored in storage apparatus 202 to perform processing and functions of each apparatus. The input/output apparatus 203 may also be configured with a keyboard and a display. In the first sketch generation apparatus 100 and second sketch generation apparatus 110 of FIG. 2, the input/output apparatus 203 may also be provided with a sensor or camera for acquiring biometric information. In this case, the sensor may be an image sensor (camera) when the biometric information to be acquired is a face, iris, etc. For a fingerprint, the sensor may be a fingerprint sensor. For finger (palm) veins, it may be, for example, an LED (Light Emitting Diode) that emits near-infrared light and a near-infrared camera that captures the light transmitted through the finger (palm). The sensor may be a removable sensor, such as a USB (Universal Serial Bus) apparatus. The communication interface 204 may be configured to include a network interface card or transceiver, enabling communicative connection via LAN (Local Area Network), WAN (Wide Area Network) such as the Internet, wireless LAN, mobile communication networks, etc. Furthermore, the communication interface 204 may be configured to communicate with a n external sensor(s) (e.g., Bluetooth®-connected sensor) and receive biometric information acquired by the external sensor(s). The programs executed by the processors 201 of the apparatuses (100, 110, 120) in FIG. 3 may be stored on a recording medium in an unillustrated program repository, downloaded respectively to the apparatuses (100, 110, 120), and stored in the storage apparatuses 202 of the apparatuses (100, 110, 120) in FIG. 3.

FIG. 10B is a schematic diagram illustrating an example where one or more of the apparatuses 100, 110, 120 of the sketch management system 1 are implemented as virtual machines using server virtualization technology. Multiple virtual machines VM303 are configured to operate on a virtualization platform 302, such as a hypervisor implemented on the physical server machine 301. One or more of the apparatuses (100, 110, 120) in the sketch management system 1 shown in FIG. 3 may be implemented as a virtual machine(s) VM(s) 303. With a single physical server, a virtual server environment where multiple servers operate is provided. Each virtual machine VM is preferably configured to operate in an isolated environment within a memory space. In this case, within the virtual machine VM, a program that implements processing of one of the apparatus (100, 110, 120) runs on the virtual machine's virtual OS (Operating System). The virtual machine VM303, which virtually implements one of the apparatus (100, 110, 120), may be configured to communicate with other virtual machines via a virtual network. Alternatively, it may be configured to communicate with other apparatus(es) (100, 110, 120) via a LAN, the Internet, or other WAN, using a physical interface(s) (communication interface(s)) of the physical machine 301. In this case, the virtual machines VM303 do not need to be executed on the same physical machine and may be configured to be communicatively connected with virtual machines VM executed on one or more other physical machines.

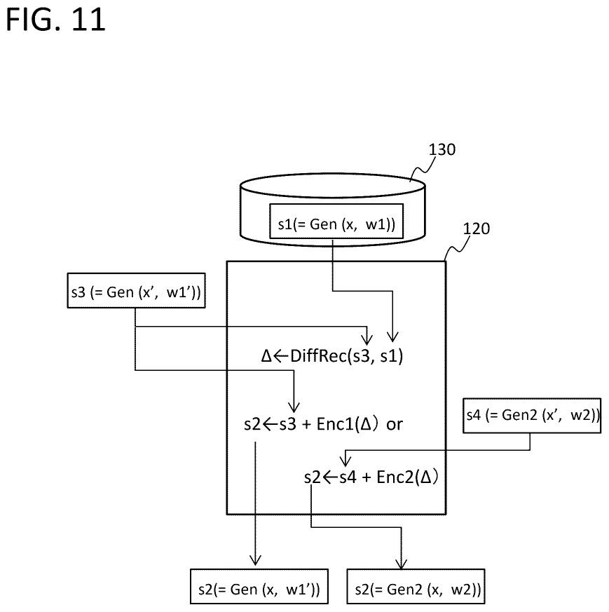

FIG. 11 is an example of FIG. 10A illustrating the processing performed by the processor 201 when implementing the sketch management apparatus 120 in the above-described several embodiments using the computer 200 of FIG. 10A. The processor 201 in FIG. 10A executes a program (not shown) stored in the storage apparatus 202 to perform, for example, the following processing.

Referring to FIG. 11, the sketch management apparatus 120 (processor 201 in FIG. 10A, regarding the first sketch s1 (=Gen(x,w1)) which was generated using the first data x and the first biometric information w1, registered in advance and has been stored in the storage apparatus 130, receives the third sketch s3 (=Gen(x′, w1′)) which was generated using the newly acquired first biometric data (w1′) with the same modality as the first biometric data (w1) and the second data (x′). reconstructs the difference data (Δ) based on the first sketch (s1) and the third sketch (s3) (Δ←DiffRec(s3, s1)). The difference data (Δ) corresponds to difference (=(x−x′)) between the first data (x) and the second data (x′) if the difference (distance) between the (newly acquired) first biometric information (w1′) used to generate the third sketch (s3) and the first biometric information (w1) used to generate the first sketch (s1) is within a predetermined range.

The sketch management apparatus 120 (processor 201 in FIG. 10A) further performs the following processing to generate the second sketch (s2) from the first sketch (s1).

In a case where the second sketch (s2) is a sketch generated using the first data (x) and the second biometric information (w2), the sketch management apparatus 120 receives a fourth sketch s4 (=Gen(x′, w2)) generated using second data (x2) and the second biometric information (w2), and generates the second sketch s2 (=Enc2(x)+w2=Gen2(x, w2)) using the fourth sketch (s4) and an encoded value (codeword) of the difference data (Δ) encoded using the error-correcting encoding function Enc2.

In a case where the second sketch (s2) is a sketch generated using the first data (x) and the first biometric information acquired anew (w1′), the sketch management apparatus 120 generates the second sketch s2 (=Enc(x)+w1′=Gen(x, w1′)) using the third sketch (s3) and an encoded value (codeword) of the difference data (Δ) encoded using the error-correcting encoding function Enc.

The above embodiments/examples may be listed as the following supplementary notes (Notes), though not limited thereto.
(Note 1) A sketch management system including: a first apparatus and a second apparatus, each including at least a processor; a memory storing a program executable by the processor; and a communication interface, each communicatively connectable to each other,
   wherein the processor included in the first apparatus configured to perform:
   regarding a first sketch generated using first data and first biometric information and registered in advance,
   acquiring first biometric information anew;
   generating second data, generating the third sketch using the second data and the first biometric information acquired anew;
   acquiring second biometric information; and
   generating a fourth sketch using the second data and the second biometric information, and
   wherein the processor included in the second apparatus configured to perform:
   obtaining the third sketch generated by the first apparatus;
   restoring difference data based on the first sketch and the third sketch, wherein the difference data corresponds to difference between the first data and the second data when difference between the first biometric information acquired anew and the first biometric information used to generate the first sketch is within a predetermined range;
   obtaining the fourth sketch generated by the first apparatus; and generating a second sketch using the fourth sketch and the difference data.
(Note 2) A sketch management system including a first apparatus and a second apparatus, each including at least a processor; a memory storing a program executable by the processor; and a communication interface, each communicatively connectable to each other,
   wherein the processor included in the first apparatus is configured to perform:
   regarding a first sketch generated using first data and first biometric information and registered in advance,
   acquiring anew first biometric information;
   generating second data; and
   generating a third sketch using the second data and the first biometric information acquired anew, and
   wherein the processor included in the second apparatus is configured to perform:
   obtaining the third sketch generated by the first apparatus;
   restoring difference data based on the first sketch and the third sketch, wherein the difference data corresponds to difference between the first data and the second data when difference between the first biometric information acquired anew and the first biometric information used to generate the first sketch is within a predetermined range, and
   generating a second sketch using the third sketch and the difference data.
(Note 3) A sketch management system including:
   a first apparatus, a second apparatus and a third apparatus, each including at least a processor; a memory storing a program executable by the processor; and a communication interface, each communicatively connectable to each other,
   wherein the processor included in the first apparatus is configured to perform:
   with respect to a first sketch generated using first data and first biometric information and registered in advance,
   acquiring anew first biometric information; and
   generating a third sketch using second data and the first biometric information acquired anew,
   wherein the processor included in the third apparatus is configured to perform:
   acquiring second biometric information; and
   generating a fourth sketch using the second data and the second biometric information, the first apparatus and the third apparatus sharing the second data, and
   wherein the processor included in the second apparatus is configured to perform:
   obtaining the third sketch generated by the first apparatus;
   restoring difference data based on the first sketch and the third sketch,
   wherein the difference data corresponds to difference between the first data and the second data when difference between the first biometric information acquired anew and the first biometric information used to generate the first sketch is within a predetermined range,
   obtaining the fourth sketch generated by the third apparatus; and generating a second sketch using the fourth sketch and the difference data.
(Note 4) In the sketch management system of Note 1, the second biometric information is either:
   biometric information, a user thereof being same as, while a modality thereof different from, the first biometric information used to generate the first sketch; or
   biometric information, a modality and user thereof both being same as, while a body part thereof different from, the first biometric information.
(Note 5) In the sketch management system of Note 1 or 3, the second biometric information is either:
   biometric information, a modality thereof being same as the first biometric information used to generate the first sketch; or
   biometric information, a modality and user thereof being different from the first biometric information used to generate the first sketch.
(Note 6) In the sketch management system of Note 1, the first sketch, the third sketch, and the fourth sketch are each generated using a generation function that takes data and biometric information as input,
   wherein the generation function generates the sketch by combining a n error-correction encoded codeword of the data taken as the input and the biometric information taken as the input, and
   wherein the processor included in the second apparatus is configured to generate the second sketch by combining the fourth sketch and an error-correction encoded codeword of the difference data encoded using an error-correcting encoding function same as that used to generate the fourth sketch.
(Note 7) In the sketch management system of Note 2, each of the first sketch and the third sketch is generated using a generation function that takes data and biometric information as input, wherein the generation function generates the sketch by combining an error-correction encoded codeword of the data taken as the input and the biometric information taken as the input, and the second apparatus is configured to generate the second sketch by combining the third sketch and an error-correction encoded codeword of the difference data encoded using the same error-correcting encoding function as that used to generate the first sketch and the third sketch.
(Note 8) In the sketch management systems of any one of Notes 1 to 7, the processor included in the second apparatus is configured to perform
   restoring the difference data by using a decoding function that takes the first sketch and the third sketch as input and performs error-correction decoding of a difference between the first sketch and the third sketch to output the difference data.
(Note 9) A sketch management method including:
by a first apparatus:
regarding a first sketch generated using first data and first biometric information and registered in advance,
   acquiring anew first biometric information;
   generating second data;
   generating a third sketch using the second data and the first biometric information acquired anew;
   acquiring second biometric information; and
   generating a fourth sketch using the second data and the second biometric information, the method including:
   by a second apparatus:
   obtaining the third sketch generated by the first apparatus; restoring difference data based on the first sketch and the third sketch, wherein the difference data corresponds to difference between the first data and the second data when difference between the first biometric information acquired anew and the first biometric information used to generate the first sketch is within a predetermined range;
   obtaining the fourth sketch generated by the first apparatus; and
   generating a second sketch using the fourth sketch and the difference data.
(Note 10) A sketch management method including:
   by a first apparatus:
   regarding a first sketch generated using first data and first biometric information and registered in advance, acquiring anew first biometric information;
   generating second data; and
   generating a third sketch using the second data and the first biometric information acquired anew, the method including:
   by a second apparatus:
   obtaining the third sketch generated by the first apparatus;
   restoring difference data based on the first sketch and the third sketch, wherein the difference data corresponds to difference between the first biometric information acquired anew and the first biometric information used to generate the first sketch, provided that the difference is within a predetermined range;
   generating a second sketch using the third sketch and the difference data.
(Note 11) A sketch management method including:
   by a first apparatus:
   regarding a first sketch generated using first data and first biometric information and registered in advance,
   acquiring anew first biometric information;
   generating second data; and
   generating a third sketch using the second data and the first biometric information acquired anew, the method including:
   by a third apparatus:
   acquiring second biometric information; and
   generating a fourth sketch using the second data and the second biometric information,
   the first apparatus and the third apparatus sharing the second data, the method further including:
   by a second apparatus:
   obtaining the third sketch generated by the first apparatus;
   restoring difference data based on the first sketch and the third sketch, wherein the difference data corresponds to difference between the first data and the second data, when difference between the first biometric information acquired anew and the first biometric information used to generate the first sketch is within a predetermined range;
   obtaining the fourth sketch generated by the third apparatus; and
   generating a second sketch using the fourth sketch and the difference data.
(Note 12) In the sketch management method of Note 9, the second biometric information is either:
   biometric information, a user thereof being same as, while a modality thereof different from, the first biometric information used to generate the first sketch; or
   biometric information, a modality and user thereof both being same as, while a body part thereof different from, the first biometric information.
(Note 13) In the sketch management method of Note 11, the second biometric information is either:
   biometric information, a modality thereof being same as the first biometric information used to generate the first sketch; or
   biometric information, a modality and user thereof being different from the first biometric information used to generate the first sketch.
(Note 14) In the sketch management method of Note 9 or 11, the first sketch, the third sketch, and the fourth sketch are each generated using a generation function that takes data and biometric information as input, wherein the generation function generates the sketch by combining the error-correcting coded codeword of the input data and the input biometric information, wherein the method includes
   generating, by the second apparatus, the second sketch by combining the fourth sketch and an error-correction encoded codeword of the difference data encoded using an error-correcting encoding function same as that used to generate the fourth sketch.
(Note 15) In the sketch management method of Note 10, each of the first sketch and the third sketch is generated using a generation function that takes data and biometric information as input, wherein the generation function generates the sketch by combining an error-correction encoded codeword of the data taken as the input and the biometric information taken as the input, wherein the method includes
   generating, by the second apparatus, the second sketch by combining the third sketch and an error-correction encoded codeword of the difference data encoded using the same error-correcting encoding function as that used to generate the first sketch and the third sketch.
(Note 16) The sketch management method of any one of Notes 9 to 15, includes restoring, by the second apparatus, the difference data by using a decoding function that takes the first sketch and the third sketch as input and performs error-correction decoding of a difference between the first sketch and the third sketch to output the difference data.
(Note 17) A non-transitory recording medium storing a program causing a first processing apparatus to execute processing including:
   regarding a first sketch generated using first data and first biometric information and registered in advance, acquiring anew first biometric information;
   generating second data;
   generating a third sketch using the second data and the first biometric information acquired anew;
   acquiring second biometric information;
   generating a fourth sketch using the second data and the second biometric information, the non-transitory recording medium storing a program causing a second processing apparatus to execute processing including:
   acquiring the first sketch and the third sketch generated by the first processing apparatus;
   restoring difference data based on the first sketch and the third sketch, wherein the difference data corresponds to difference between the first data and the second data when difference between the first biometric information acquired anew and the first biometric information used to generate the first sketch is within a predetermined range;
   obtaining the fourth sketch generated by the first processing apparatus; and
   generating a second sketch using the fourth sketch and the difference data.
(Note 18) A non-transitory recording medium storing a program causing a first processing apparatus to execute processing including:
   regarding a first sketch generated using first data and first biometric information and registered in advance, acquiring anew first biometric information;
   generating second data;
   generating a third sketch using the second data and the first biometric information acquired anew, the non-transitory recording medium storing a program causing a second processing apparatus to execute processing including:
   obtaining the third sketch generated by the first processing apparatus;
   restoring difference data based on the first sketch and the third sketch, wherein the difference data corresponds to difference between the first data and the second data when difference between the first biometric information acquired anew and the first biometric information used to generate the first sketch is within a predetermined range; and
   generating a second sketch using the third sketch and the difference data.
(Note 19) A non-transitory recording medium storing a program causing a first processing apparatus to execute processing including:
   regarding a first sketch generated using first data and first biometric information and registered in advance, acquiring anew first biometric information;
   generating second data;
   generating a third sketch using the second data and the first biometric information acquired anew, the non-transitory recording medium storing a program causing a third processing apparatus to execute processing including:
   acquiring second biometric information; and
   generating a fourth sketch using the second data and the second biometric information,
   the first processing apparatus and the third processing apparatus sharing the second data, the non-transitory recording medium storing a program causing a second processing apparatus to execute processing including:
   obtaining the third sketch generated by the first processing apparatus;
   restoring difference data based on the first sketch and the third sketch, wherein the difference data corresponds to difference between the first data and the second data, when difference between the first biometric information acquired anew and the first biometric information used to generate the first sketch is within a predetermined range;
   obtaining the fourth sketch generated by the third processing apparatus; and
   generating a second sketch using the fourth sketch and the difference data.
(Note 20) A sketch management apparatus includes a processor and a communication interface, wherein the processor is configured to:
   regarding a first sketch generated using first data and first biometric information and registered in advance,
   receive a third sketch generated using the first biometric information acquired anew and second data;
   restore difference data based on the first sketch and the third sketch, wherein the difference data corresponds to difference between the first data and the second data when difference between the first biometric information acquired anew and used to generate the third sketch and the first biometric information used to generate the first sketch is within a predetermined range;
   as a process for generating a second sketch from the first sketch,
   in case where the second sketch is a sketch generated using the first data and the second biometric information,
   receive a fourth sketch generated using the second data and the second biometric information, and
   generate the second sketch using the fourth sketch and the difference data;
   in case where the second sketch is a sketch generated using the first data and the first biometric information acquired anew,
   generate the second sketch using the third sketch and the difference data.
(Note 21) A non-transitory recording medium stores a program causing a processor to execute processing including:
   regarding a first sketch generated using first data and first biometric information and registered in advance,
   receiving a third sketch generated using the first biometric information acquired anew and second data;
   restoring difference data based on the first sketch and the third sketch, wherein the difference data corresponds to difference between the first data and the second data when difference between the first biometric information acquired anew and used to generate the third sketch and the first biometric information used to generate the first sketch is within a predetermined range;
   as a process for generating a second sketch from the first sketch,
   in case where the second sketch is a sketch generated using the first data and the second biometric information,
   receiving a fourth sketch generated using the second data and the second biometric information, and
   generating the second sketch using the fourth sketch and the difference data;
   in case where the second sketch is a sketch generated using the first data and the first biometric information acquired anew,
   generating the second sketch using the third sketch and the difference data.

### REFERENCE LITERATURE

[Reference Literature 1] TAKAHASHI, Kenta, MATSUDA, Takahiro, MURAKAMI, Takao, HANAOKA, Goichiro, NISHIGAKI, Masakatsu. “Signature Schemes with a Fuzzy Private Key”,
T. Malk et al. (Eds): ANCS (Applied Cryptography and Network Security) 2015, LNCS (Applied Cryptography and Network Security) 9092, Springer International Publishing 2015, pp 105-126.
[Reference Literature 2] Japanese Patent Application Publication No. 2021-087167
[Reference Literature 3] Japanese Patent Publication No. 7215559
[Reference Literature 4] Japanese Patent Publication No. 5707311
[Reference Literature 5] Haruna Higo, Toshiyuki Isshiki, Saki Otsuki, Kenji Yasunaga, “Fuzzy Signature with Biometric-Independent Verification”, 2023 International Conference of the Biometrics Special Interest Group (BIOSIG), IEEE, 20-22 Sep. 2023
[Reference Literature 6] Derler, David/Slamanig, Daniel. “Key-homomorphic signatures: definitions and applications to multiparty signatures and non-interactive zero-knowledge.” Designs, Codes and Cryptography, Vol. 87.

The disclosures of each of the above-mentioned documents are hereby incorporated by reference into this document. Within the scope of the disclosure of the present application (including the claims), modifications, adjustments, and combinations of embodiments or examples based on the fundamental technical concept are possible. Furthermore, within the scope of the claims of the present disclosure, various combinations or selections of the disclosed elements (including each element of the appended claims, each element of the embodiments, each element of the drawings, etc.) are possible. That is, the present disclosure naturally encompasses the entire disclosure, including the claims, and various modifications and alterations that would be obvious to one skilled in the art based on the technical concept.

What is claimed is:

1. A sketch management system comprising:
a first apparatus and a second apparatus, each including at least a processor; a memory storing a program executable by the processor; and a communication interface, each communicatively connectable to each other, wherein
the processor included in the first apparatus is configured to perform:
regarding a first sketch generated using first data and first biometric information and registered in advance,
acquiring anew first biometric information;
generating second data;
generating a third sketch using the second data and the first biometric information acquired anew;
acquiring second biometric information; and
generating a fourth sketch using the second data and the second biometric information, and wherein
the processor included in the second apparatus is configured to perform:
obtaining the third sketch generated by the first apparatus;
restoring difference data based on the first sketch and the third sketch, wherein the difference data corresponds to difference between the first data and the second data when difference between the first biometric information acquired anew and the first biometric information used to generate the first sketch is within a predetermined range; obtaining the fourth sketch generated by the first apparatus; and
generating a second sketch using the fourth sketch and the difference data.

2. A sketch management system comprising:
a first apparatus and a second apparatus, each including at least a processor; a memory storing a program executable b y the processor; and a communication interface, each communicatively connectable to each other, wherein
the processor included in the first apparatus is configured to perform:
regarding a first sketch generated using first data and first biometric information and registered in advance,
acquiring anew first biometric information;
generating second data; and
generating a third sketch using the second data and the first biometric information acquired anew, and wherein
the processor included in the second apparatus is configured to perform:
obtaining the third sketch generated by the first apparatus;
restoring difference data based on the first sketch and the third sketch, wherein the difference data corresponds to difference between the first data and the second data when difference between the first biometric information acquired anew and the first biometric information used to generate the first sketch is within a predetermined range; and
generating a second sketch using the third sketch and the difference data.

3. The sketch management system according to claim 1, comprising
a third apparatus including at least a processor; a memory storing a program executable by the processor; and a communication interface, the third apparatus communicatively connectable to the first apparatus and the second apparatus, wherein the processor included in the third apparatus is configured to perform in place of the first processor:
acquiring the second biometric information; and
generating the fourth sketch using the second data and the second biometric information, the first apparatus and the third apparatus sharing the second data, and wherein
the processor included in the second apparatus is configured to perform:
obtaining the third sketch generated by the first apparatus;
restoring the difference data based on the first sketch and the third sketch;
obtaining the fourth sketch generated by the third apparatus; and
generating the second sketch using the fourth sketch and the difference data.

4. The sketch management system according to claim 1, wherein the second biometric information is either:
biometric information, a user thereof being same as, while a modality thereof different from, the first biometric information used to generate the first sketch; or
biometric information, a modality and user thereof both being same as, while a body part thereof different from, the first biometric information.

5. The sketch management system according to claim 3, wherein the second biometric information is either:
biometric information, a modality thereof being same as the first biometric information used to generate the first sketch; or
biometric information, a modality and user thereof being different from the first biometric information used to generate the first sketch.

6. The sketch management system according to claim 1, wherein the first sketch, the third sketch, and the fourth sketch are each generated using a generation function that takes data and biometric information as input,
wherein the generation function generates the sketch by combining a n error-correction encoded codeword of the data taken as the input and the biometric information taken as the input, and
wherein the processor included in the second apparatus is configured to generate the second sketch by combining the fourth sketch and an error-correction encoded codeword of the difference data encoded using an error-correcting encoding function same as that used to generate the fourth sketch.

7. The sketch management system according to claim 2, wherein each of the first sketch and the third sketch is generated using a generation function that takes data and biometric information as input,
wherein the generation function generates the sketch by combining an error-correction encoded codeword of the data taken as the input and the biometric information taken as the input, and
wherein the processor included in the second apparatus is configured to generate the second sketch by combining the third sketch and an error-correction encoded codeword of the difference data encoded using an error-correcting encoding function same as that used to generate the first sketch and the third sketch.

8. The sketch management system according to claim 1, wherein the processor included in the second apparatus is configured to perform
restoring the difference data by using a decoding function that takes the first sketch and the third sketch as input and performs error-correction decoding of a difference between the first sketch and the third sketch to output the difference data.

9. The sketch management system according to claim 1, wherein the first sketch is registered in association with a user ID in a storage apparatus that is provided in the second apparatus or communicatively accessible by the second apparatus, wherein the processor included in the second apparatus is configured to obtain the first sketch registered in the storage apparatus using a user ID.

10. A sketch management method comprising:
by a first apparatus:
regarding a first sketch generated using first data and first biometric information and registered in advance,
acquiring anew first biometric information;
generating second data;
generating a third sketch using the second data and the first biometric information acquired anew;
acquiring second biometric information; and
generating a fourth sketch using the second data and the second biometric information, the method including:
by a second apparatus:
obtaining the third sketch generated by the first apparatus;
restoring difference data based on the first sketch and the third sketch, wherein the difference data corresponds to difference between the first data and the second data when difference between the first biometric information acquired anew and the first biometric information used to generate the first sketch is within a predetermined range;
obtaining the fourth sketch generated by the first apparatus; and
generating a second sketch using the fourth sketch and the difference data.

11. The sketch management method according to claim 10, wherein the second biometric information is either:
biometric information, a user thereof being same as, while a modality thereof different from, the first biometric information used to generate the first sketch; or
biometric information, a modality and user thereof both being same as, while a body part thereof different from, the first biometric information.

12. The sketch management method according to claim 10, wherein the second biometric information is either:
biometric information, a modality thereof being same as the first biometric information used to generate the first sketch; or
biometric information, a modality and user thereof being different from the first biometric information used to generate the first sketch.

13. The sketch management method according to claim 10, wherein the first sketch, the third sketch, and the fourth sketch are each generated using a generation function that takes data and biometric information as input, wherein the generation function generates the sketch by combining an error-correction encoded codeword of the data taken as the input and the biometric information taken as the input,
the method comprising
generating, by the second apparatus, the second sketch by combining the fourth sketch and an error-correction encoded codeword of the difference data encoded using an error-correcting encoding function same as that used to generate the fourth sketch.

14. The sketch management method according to claim 10, comprising
performing, by the second apparatus, restoring the difference data by using a decoding function that takes the first sketch and the third sketch as input and performs error-correction decoding of a difference between the first sketch and the third sketch to output the difference data.
